(19) United States
(12) Patent Application Publication
(10) Pub. No.: US 2010/0217451 A1
(43) Pub. Date: Aug. 26, 2010

(54) ENERGY USAGE CONTROL SYSTEM AND METHOD

(76) Inventors: Tetsuya Kouda, Osaka (JP); Satoshi Tsujimura, Hyogo (JP); Naofumi Nakatani, Osaka (JP); Yasuo Yoshimura, Nara (JP); Kazunori Kurimoto, Hyogo (JP)

Correspondence Address: Brinks Hofer Gilson & Lione/Panasonic, P.O. Box 10395, Chicago, IL, 60610, US

(21) Appl. No.: 12/710,610

(22) Filed: Feb. 23, 2010

(30) Foreign Application Priority Data
Feb. 24, 2009 (JP) 2009-040809
Mar. 11, 2009 (JP) 2009-057726
Jul. 6, 2009 (JP) 2009-159527
Dec. 28, 2009 (JP) 2009-297429

(51) Int. Cl. G06F 1/32

(52) U.S. Cl. 700/291; 700/295

(57) ABSTRACT

The present invention provides a coordinating node in an energy usage control system. The coordinating node receives trade-off functions from energy consuming nodes. The coordinating node and the energy consuming nodes collectively form a domain. A trade-off function from an energy consuming node describes a relationship between a result of energy consumption by the energy consuming node and a degree of satisfaction towards the result. The coordinating node develops policies respectively for the energy consuming nodes, based on the received trade-off functions. The policies each contain at least one goal and/or at least one procedure to guide the respective energy consuming node to control its energy usage such that the energy consuming nodes collectively achieve an optimum energy saving for the domain.

### RELATED APPLICATIONS

This application claims priority under 35 U.S.C. §119 to Japanese Patent Application Nos. 2009-040809 filed on Feb. 24, 2009, 2009-057726 filed on Mar. 11, 2009, 2009-159527 filed on Jul. 6, 2009, and 2009-297429 filed on Dec. 28, 2009, the entire contents of which are hereby incorporated by reference.

### BACKGROUND OF THE INVENTION

1. Field of the Invention

This patent application relates to a system for controlling energy usage or energy consumption to achieve the optimum energy saving and more particularly to a system in which at least one coordinating node develops a policy regarding energy consumption of at least one energy consuming node which implements the policy to thereby achieve the optimum energy saving in the system.

2. Description of the Related Art

The electric industry is poised to make the transformation from a centralized producer-controlled network to one that is less centralized and more consumer-interactive. One exemplary effort for the transformation is the move to adopting a smart grid. Adaptation of the smart grid is expected to enhance the electric delivery system, including generation, transmission, distribution and consumption. It is expected to encourage consumers to modify patterns of electricity usage, including the timing and level of electricity demand. It is also expected to increase the possibilities of distributed generation, bringing generation closer to those it serves.

The smart grid is an automated, widely distributed energy delivery network and characterized by a two-way flow of electricity and information and capable of monitoring everything from power plants to consumer preferences to individual appliances. It incorporates into the grid the benefits of distributed computing and communications to deliver real-time information and enable the near-instantaneous balance of supply and demand at the device level. It is thus expected to explore the state of the grid at the national level and switch within seconds to explore specific details at the street level. It is also expected to provide rapid information about blackouts and power quality as well as insights into system operation for utilities.

Another effort for the industry's transformation is the deployment of smart meters. Smart meters identify consumption in more detail than a conventional meter and communicate that information back to the local utility for monitoring and billing purposes. Smart meters can provide consumers with the ability to use electricity more efficiently and provide utilities with the ability to detect problems on their systems and operate them more efficiently.

All of these efforts intend to realize an electric delivery system with less centralized control of electricity usage, but the intended electric delivery system may fall short of expectation. Integrated operations of the smart grid and the smart meters will generate zillions of bits of information flows exchanged in the nationwide network. This enormous amount of information will probably significantly slow down the constituent computers and impose significant load on the communication systems, resulting in delayed decisions to manage electricity usage in the system.

### SUMMARY OF THE INVENTION

In view of the above problem, the present invention provides a coordinating node that provides polices to energy consuming nodes. The coordinating node and the energy consuming nodes collectively form a domain. The energy consuming nodes implement policies to thereby collectively achieve the optimum energy consumption.

The first aspect of the invention provides a coordinating node that comprises a receiver that receives trade-off functions from energy consuming nodes. The trade-off function from an energy consuming node describes a relationship between a result of energy consumption by the energy consuming node and a degree of satisfaction towards the result. The coordinating node further comprises a policy developer that develops policies respectively for the energy consuming nodes, based on the received trade-off functions. The policies each contain at least one goal and/or at least one procedure to guide the respective energy consuming node to control its energy usage such that the energy consuming nodes collectively achieve an optimum energy saving for the domain.

The coordinating node may have a general policy which contains at least one goal and/or at least one procedure to guide the policy developer to develop the policies. The general policy may contain a total amount of energy to be saved by the energy consuming nodes in the domain.

The coordinating node may comprise a transmitter that broadcasts a directive signal requesting the energy consumption nodes to send their trade-off functions to the coordinating node. The transmitter may broadcast the directive signal at regular intervals, e.g., every 24 hours.

The coordinating node may further comprise a registrar that receives a notice from energy consuming nodes active in the domain at regular intervals and registers the active energy consuming nodes in a registration table in the memory. The registrar adds a new energy consuming node in the registration table when it receives for the first time the notice from the new energy consuming node and deletes a registered energy consuming node from the registration table when the registrar fails to receive the notice of the registered energy consuming node for a predetermined time period. The transmitter broadcasts the directive signal to the registered energy consuming nodes when the new energy consuming node is added in the registration table or the registered energy consuming node is deleted from the registration table.

The energy consuming nodes may be electric appliances including any of an air conditioner, a refrigerator, a washer-dryer, a toaster, a rice cooker, a heat-pump water heater an induction heather. The energy consuming nodes may be air conditioners and the coordinating node may be a remote controller for the air conditioners. If the energy consuming nodes are air conditioners, the policy contains a target temperature or an amount of energy to be saved.

The energy consuming node receives a policy from the coordinating node. The energy consuming node comprises a node director that implements the policy according to which the energy consuming node is operated to thereby achieve a result expected to achieve under implementation of the policy. In implementing the policy, an operation monitor monitors energy usage by the energy consuming node to predict whether the energy consuming node will have consumed more energy than allowed under implementation of the policy. If it is predicted that the energy consuming node will have consumed more energy than allowed under implementation of the policy, a new result finder determines a new result which is compromised from the expected result such that the energy consuming node will have consumed energy substantially equal to or less than allowed under implementation of the policy. A new result examiner then determines whether the new result is within an acceptable range of the result determined based on the trade-off function. If the compromised result is without the acceptable range, a new policy is requested from the coordinating node.

A new policy may be requested if the operation monitor predicts that the energy consuming nodes will have consumed significantly less energy than allowed under implementation of the policy. The energy consuming node may comprise a policy modifier that, if the compromised result is within the acceptable range, modifies the policy according to the compromised result such that the energy consuming node is operated to thereby achieve the compromised result under implementation of the modified policy.

If the energy consuming node is preferred to operate not to compromise the degree of satisfaction, the energy consuming node may be operated to achieve the result expected to achieve under implementation of the received policy, even if it is predicted that the energy consuming node will have consumed more energy than allowed under implementation of the received policy.

A lowest acceptable result in the acceptable range of the result is derived from the trade-off function with a minim acceptable degree of satisfaction. The energy consuming node may receive a complaint on the result, and the operation monitor monitors complaints on the results and analyzes the complaints in relation to the degrees of satisfaction. The minimum acceptable degree of satisfaction is a threshold observed in a distribution of the complaints.

The energy consuming node may comprise a function updater that analyzes complaints on the results and updates the relationship in the trade-off function between the result of energy consumption and the degree of satisfaction towards the result, based on a distribution of the complaints in relation to the results. In response to a directive signal from the coordinating node, the energy consuming node reports the updated trade-off function to the coordinating node.

The relationship between the result of energy consumption and the degree of satisfaction towards the result is updated to coincide with a normal distribution of the complaints in relation to the results. The complaints may contain desired results, and the normal distribution is defined with a mean and a variance calculated with the requested results. If the energy consuming node is an air conditioner, the complaint is a temperature setting including a desired temperature, and the relationship between the temperatures maintained and the degrees of satisfaction towards the temperatures is updated to coincide with a normal distribution having a mean and a variance calculated with the desired temperatures in the complaints.

The energy consuming node may comprise a translator that describes a relationship between the result of energy consumption and an amount of energy savable with the result. The function updater updates the relationship between the result of energy consumption and the amount of energy savable with the result, based on the monitored energy usage. The translator may be reported to the coordinating node after the relationship between the result of energy consumption and an amount of energy savable with the result is updated.

The present invention also provides an energy usage control system comprised of the above coordinating node and energy consuming nodes. The system may include an energy generating node.

### BRIEF DESCRIPTION OF THE DRAWINGS

FIG. 1 is a schematic view showing one type of domain containing a coordinating node and energy consuming nodes.

FIG. 2 is a block diagram explaining general functions of the coordinating node and energy consuming node.

FIG. 3 is a flowchart showing communications exchanged between the coordinating node and energy consuming nodes as shown in FIG. 2.

FIG. 4 is a schematic view showing another type of domain containing a coordinating node, pseudo energy consuming nodes and energy consuming nodes.

FIG. 5 is a flowchart showing communications exchanged between the coordinating node and energy consuming nodes as shown in FIG. 4.

FIG. 6 is a schematic view showing another type of domain containing a coordinating node, a pseudo energy consuming node and energy consuming nodes.

FIG. 7A is a block diagram showing functional modules of an energy consuming node according to one embodiment of the present invention.

FIG. 7B is a block diagram showing the hardware structure of the controller 7-3.

FIG. 8A is a block diagram showing functional modules of a coordinating node according to one embodiment of the present invention.

FIG. 8B is a block diagram showing the hardware structure of the controller 8-3.

FIG. 9 is a flowchart showing processes performed by the coordinating node shown in FIG. 8A.

FIG. 10 is a timing chart showing timings the processes shown in FIG. 9 are performed at the coordinating node.

FIG. 11 is a block diagram showing another embodiment of the present invention in which the energy consuming nodes are air conditioners and the coordinating node is a remote controller of the air conditioners.

FIG. 12 is a block diagram showing functional modules of the coordinating node shown in FIG. 11.

FIG. 13 is a timing chart showing timings the coordinating node develops policies for the energy consuming nodes.

FIG. 14 is a table showing a trade-off function according to one embodiment of the present invention.

FIG. 15 show tables prepared by two air conditioners shown in FIG. 11.

FIG. 16 is a table in which the tables shown in FIG. 15 are combined.

FIG. 17 is a table in which the lines in the table shown in FIG. 15 are rearranged in such a manner that a line having a smaller value of the total temperature difference comes up in the table.

FIG. 18 is a block diagram showing functional modules of the air conditioner as shown in FIG. 11.

FIGS. 19A and 19B are flow charts showing processes performed by the air conditioner shown in FIG. 11.

FIG. 20 is a graph showing an exemplary function of the degree of satisfaction.

FIG. 21 is a graph showing an original function of the degree of satisfaction and modified functions of the degree of satisfaction.

FIG. 22 is a time chart showing changes of energy consumptions by three air conditioners according to one embodiment of the present invention.

FIG. 23 is a time chart showing changes of energy consumptions by three air conditioners according to another embodiment of the present invention.

FIG. 24 is a time chart showing changes of energy consumptions by four air conditioners according to another embodiment of the present invention.

### DETAILED DESCRIPTION OF THE PREFERRED EMBODIMENTS

Some of the embodiments of the present invention will be explained with an example of controlling electricity usage. It should be noted however that the present invention is applicable to controlling usage of energy of any kinds, including not only electricity but also other kinds of energy such as liquid and gaseous energy.

Control of energy usage according to the present application is contemplated to be implemented in a domain. A domain is formed by a group of nodes. A node in a domain may be an energy consuming node (EN) which consumes energy to perform an expected function, a coordinating node (CN) which coordinates energy consumptions of ENs in the domain and a pseudo energy consuming node (PN) which is actually a CN but pretends to be an EN in the domain and coordinates energy consumptions of ENs belonging to another domain. A domain may be defined with any number of nodes which function for a common administrative, geographic, temporal, legal or political interest or purpose. A household may define a domain in which nodes are electric and gas household appliances, such as air conditioners and refrigerators. A domain may be defined by a geographical region containing a plurality of households as nodes. A domain may be defined by a city containing factories in the city as nodes or defined by a county containing cities in the county as nodes.

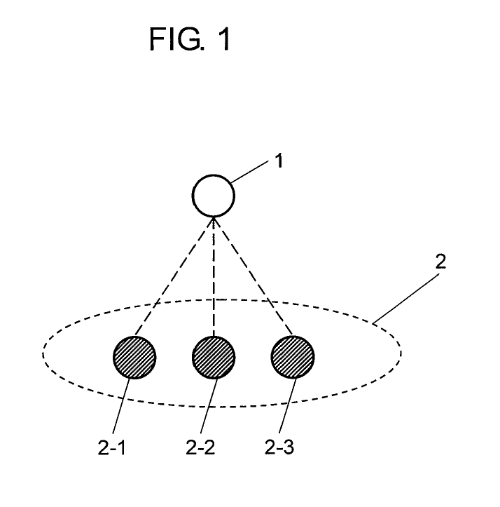

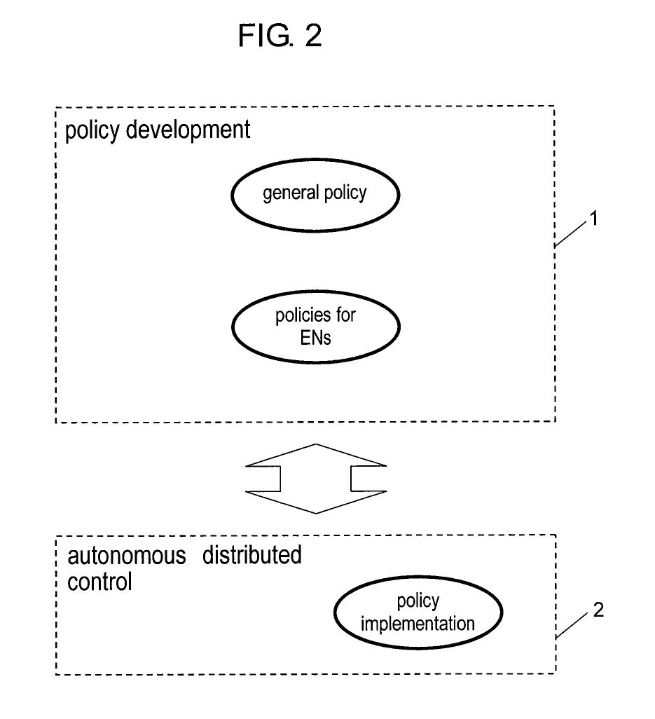

FIG. 1 shows a schematic view showing an exemplary domain. In FIG. 1, the domain contains one CN 1 and three ENs 2-1, 2-2 and 2-3. The CN and the ENs perform separate roles in the domain as generally shown in FIG. 2. The CN 1 implements a general policy according to which it develops policies regarding energy usages by the ENs 2. The ENs 2 each implement a received policy according to which each controls its energy consumption. The policies for the ENs 2 are designed to achieve the optimum energy usage in the domain as a whole by being implemented by the ENs 2 in the domain.

As a machine of purpose and function, an EN 2 is designed to perform a function by consuming energy. An amount of energy consumed by an EN 2 to achieve its intended function may be evaluated in view of a result obtained by performing the function. The present invention introduces a numerical standard to quantify a user's satisfaction towards the result obtained from the performed function. One embodiment of the present invention introduces a quantitatively defined degree of satisfaction towards the result to thereby evaluate the amount of energy consumed. It is usually the case within the normal operation range that when more energy is allowed to be consumed, higher performance is achievable and more satisfaction towards the result is obtainable, whereas when usage of energy is restricted, less satisfaction towards the result is obtained. Therefore, a trade-off relationship exists between the amount of energy consumed to achieve a result and the degree of satisfaction towards the result. In one embodiment of the present invention, the trade-off relationship between the amount of energy consumed to achieve a result and the degree of satisfaction towards the result is quantitatively defined by a trade-off function peculiar to each of the ENs 2.

In one embodiment, the degree of satisfaction is defined, using survey data collected from a large group of people. Survey data is used to derive a general function which predicts how people's degree of satisfaction towards a result will change, as the result changes. Please note that the degree of satisfaction defined with survey data may provide an objective standard for evaluating satisfaction, but may not accurately reflect the actual sense of satisfaction personal to a particular user. In one embodiment of the present invention, therefore, the degree of satisfaction is first defined with survey data and later modified according to the user's individual sense of comport by monitoring the user's behaviors towards the result. In one embodiment, an EN 2 is designed to receive a complaint from the user and record a history of complaints raised by the user. The EN 2 then analyzes the history and updates the degree of satisfaction so that it accurately reflects the actual satisfaction of the user towards the result. In another embodiment, the degree of satisfaction is updated, based on a distribution of the complaints in relation to the results. Since the trade-off function is based on the degree of satisfaction, when the degree of satisfaction is modified, so is the trade-off function.

The trade-off functions used in the present invention are expected to be peculiar to the respective ENs 2. In general, ENs 2 of different kinds naturally have different trade-off functions. Even ENs 2 of the same kind are expected to have different trade-off functions because their installation locations, their installation purposes, and/or their operation environments may be different. Although the trade-off functions are unique to the respective ENs 2, they are comparable to each other. In order to make the trade-off functions comparable, in the present invention, the degree of satisfaction is defined in a quantitative manner common to all the ENs 2.

The CN 1 implements a general policy according to which it develops policies for the ENs 2, using the trade-off functions from the ENs 2. The general policy is a plan of action containing goals and procedures to guide the CN 1 to develop policies for the ENs 2. In developing policies under a general policy to achieve the optimum energy saving in the domain, the CN 1 uses the trade-off functions from the ENs 2 to explore a better balance at each EN 2 between the amount of energy consumed and the degree of satisfaction towards the result of the energy consumption. The policy for an EN 2 is also a plan of action containing goals and procedures to guide the EN 2 to make decisions regarding its energy usage during operation. The general policy may guide the CN 1 to give different priorities to the individual ENs 2 while developing the policies for them. For instance, suppose that the ENs 2 are business establishments. If the EN 2-1 is a business office, the required level of energy consumption by the business office may be compromised. However, if the EN 2-2 is a hospital, the required level of energy consumption for the hospital may not be compromised.

In the present invention, the CN 1 may develop policies at regular time intervals. In one embodiment, for instance, the CN 1 develops policies every 24 hours. When the time comes to develop new policies, the CN 1 requests the ENs 2 to send their trade-off functions to the CN 1. Frequent requests at relatively short time intervals should be avoided, as they increase computational load on the nodes and the communication system connecting the nodes. An EN 2 may trigger the CN to develop the policies for the ENs in the domain, without waiting for a request from the CN 1. When triggered by the EN, the CN 1 requests the trade-off function from the ENs 2 to develop and distribute new policies. The CN may initiate the policy developing process when it receives a new general policy. The CN may also initiate the policy developing process when a new EN is found to have joined the domain, or when a connected EN is found no longer active in the domain.

An EN 2 may request a new policy from the CN 1 when it predicts that it will likely have consumed more energy than expected under the policy or it will likely have consumed less energy than expected under the policy. Suppose that the operation environment surrounding the EN 2 deteriorates and that the EN 2 expects to consume more energy than allowed to consume under implementation of the policy being in effect. When the EN 2 so predicts, it may request a new, loose policy to allow the EN 2 to consume more energy. On the other hand, if the operation environment surrounding the EN 2 improves such that the EN 2 expects to consume less energy than allowed under implementation of the policy, the EN 2 may request a new, tight policy from the CN 1 to allocate the excess energy to other ENs 2 which may need more energy to implement their policies.

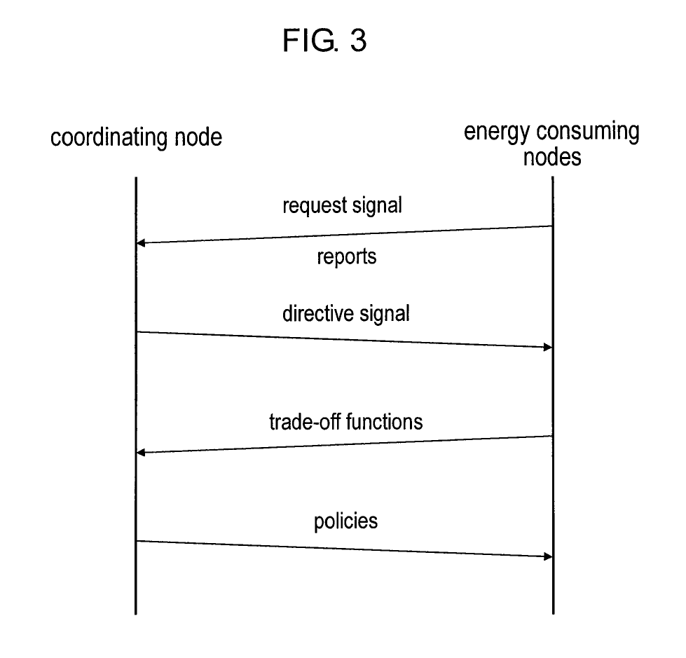

FIG. 3 shows exemplary communications exchanged between a CN and ENs in a domain according to one embodiment of the present invention. The CN 1 and the ENs 2 are connected through either a wired or wireless communication path. On a regular basis, e.g., daily, weekly or monthly, the CN 1 broadcasts a directive signal to the ENs 2. The ENs 2 then send their trade-off functions back to the CN 1. The CN 1 develops new policies, using the received trade-off function, and sends them respectively to the ENs 2. The CN 1 may broadcast the directive signal when it receives a new general policy.

When an EN 2 determines that the policy being in effect is obsolete and needs a new policy, for instance when the EN 2 predicts that it will likely have consumed more energy than expected under implementation of the policy or it will likely have consumed less energy, the EN 2 may send a request signal to the CN 1 (FIG. 3). In response, the CN 1 broadcasts the directive signal to request the trade-off functions form the ENs 2. In one embodiment, the ENs 2 each send a report to the CN 1 at relatively short time intervals. The report may, for example, contain an energy consumption rate by the sending EN. The report functions to notify the CN 1 that the EN 2 sending the report is an active energy consumption node in the domain. The CN 1 has a registration table which registers the ENs 2 active in the domain. The table is maintained in such a way that when the CN 1 receives a report from a new EN which is not registered in the table, the CN 1 considers that the EN 2 just joined the domain. The CN 1 then registers the new EN in the table and initiates the policy developing process by broadcasting the directive signal to all of the registered ENs 2. On the other hand, if the CN 1 fails to receive a report from a registered EN 2 for a predetermined time period, the CN 1 considers that the EN is no longer active in the domain. The CN 1 then deletes the EN 2 from the registration table and initiates the policy developing process by broadcasting the directive signal to the registered ENs 2.

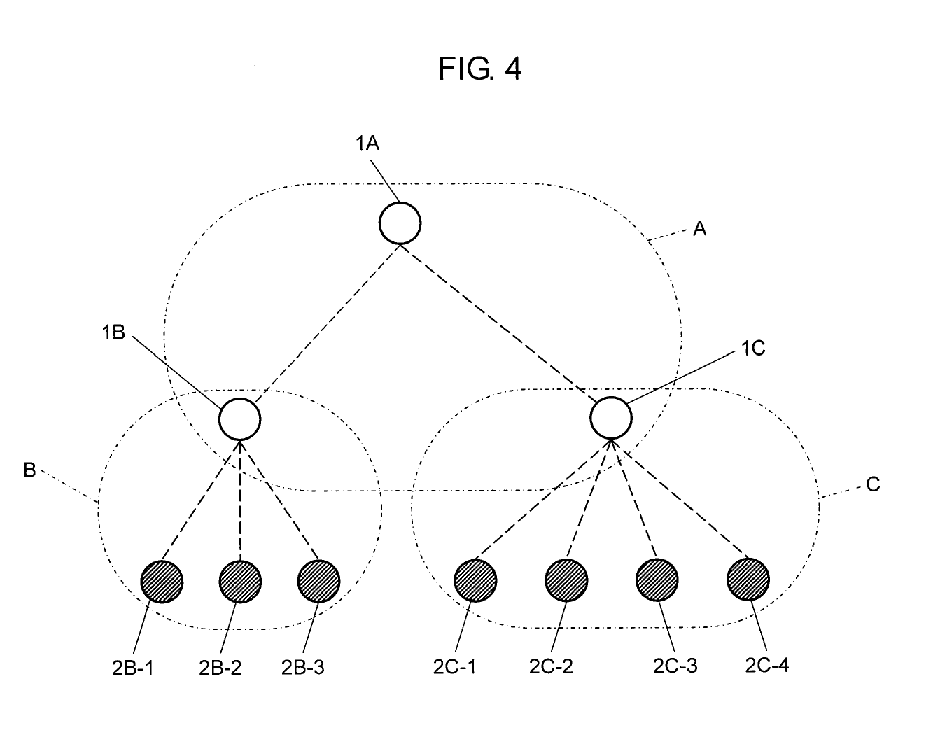

FIG. 4 shows another embodiment of the present invention. The nodes are connected through either a wired or wireless communication path. There are three domains formed in FIG. 4. The first domain (domain A) includes a CN 1A, a pseudo energy consuming node (PN) 1B and a PN 1C. As explained above, a pseudo coordinating node is a coordinating node (CN) but pretends to be an energy consumption node (EN). The second domain (domain A) includes the PN 1B and three ENs 2B-1, 2B-2 and 2B-3. The third domain (domain C) includes the PN 1C and four ENs 2C-1, 2C-2, 2C-3 and 2C-4. In the domain B, the PN 1B develops policies for the ENs 2B-1, 2B-2 and 2B-3, based on the trade-off functions of these ENs. The ENs 2B-1, 2B-2 and 2B-3 implement the policies and, guided by the policies, achieve the optimum energy usage in the domain B as a whole. Likewise, the PN 1C develops polices, which are implemented by the ENs 2C-1, 2C-2, 2C-3 and 2C-4 to thereby achieve the optimum energy usage in the domain C.

The PN 1B monitors energy consumption in the domain B and prepares a trade-off function for the domain B. Likewise, the PN 1C prepares a trade-off function for the domain C. At the request from the CN 1A, the PN 1B and the PN 1C send these trade-off functions to the CN 1A. Using the received trade-off functions, the CN 1A develops policies for the PNs 1B and 1C. Please note that for the CN 1A, the PNs 1B and 1C are not coordinating nodes but behave like energy consuming nodes. The policies received from the CN 1A are general policies for the PNs 1B and 1C. The PNs 1B and CN implement the general policies according to which they develop the policies for their ENs 2.

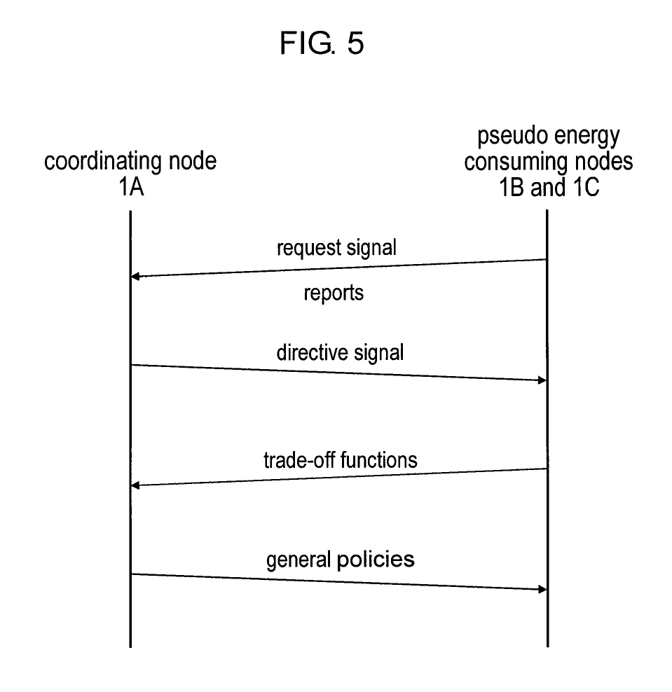

FIG. 5 shows communications exchanged between the CN 1A and the PNs 1B and 1C. The CN 1A broadcasts the directive signal to the PNs 1B and 1C at regular intervals, e.g., daily, weekly or monthly. In response, the PNs 1B and 1C send their trade-off functions to the CN 1A. Using the trade-off functions, the CN 1A develops general policies for the PNs 1B and 1C. The CN 1A may broadcast the directive signal when it receives a new general policy. By sending the request signal to the CN 1, either the PN 1B or 1C may request the CN 1A to develop new general policies when it needs a new policy. The PNs 1B and 1C send a report at regular intervals to the CN 1 so that they are kept registered in the registration table in the CN 1. By monitoring the incoming reports, the CN 1 can find if a new node has joined the domain A, or if the PN 1B or 1C has become inactive in the domain A. The CN 1 may broadcast the directive signal at such occasions.

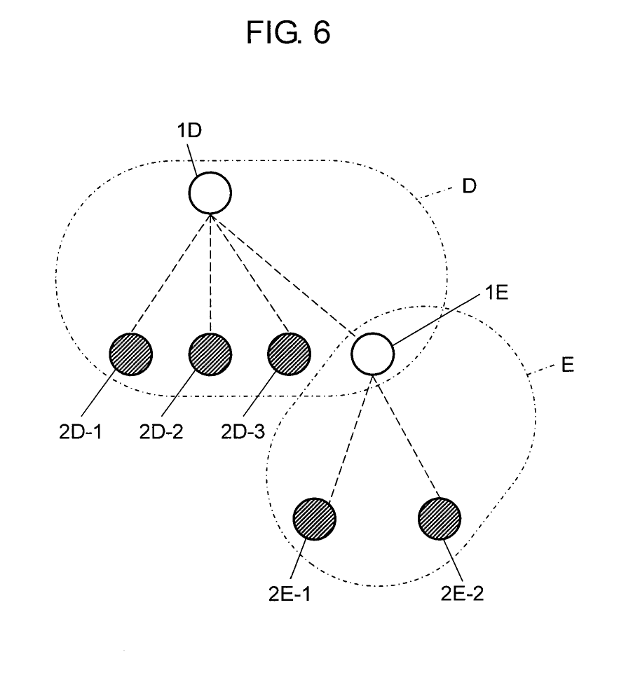

FIG. 6 shows another embodiment of the present invention. There are two domains (domains D and E) formed in FIG. 6. The domain D includes a CN 1D, three ENs 2D-1, 2D-2 and 2D-3 and a PN 1E. The domain E includes the PN 1E and two ENs 2E-1 and 2E-2. The CN 1D receives trade-off functions from the three ENs 2D and the PN 1E and develops policies for them. The ENs 2D and the PN 1E implement the policies to thereby achieve the optimum energy usage in the domain D. The policy for the PN 1E is a general policy which is implemented by the PN 1E to develop policies for the ENs 2E-1 and 2E-2, using the trade-off functions from these ENs. The ENs 2E-1 and 2E-2 implement the policies to thereby achieve the optimum energy consumption in the domain E.

As shown in FIGS. 4 and 6, two domains may overlap via a pseudo coordinating node. It is thereby possible to dynamically form domains, yet keep simple the processes performed in the domains because the process performed in a domain is closed in the domain, and development of polices in one domain does not require any considerations to energy consumed in other overlapping domains. By using combinations of the examples shown in FIGS. 1, 4 and 6, domains of various sizes may be defined in an overlapping manner.

In the above examples, a node is either a coordinating node (CN) or an energy consumption node (EN). A node may be an energy supplying or generating node. An energy generating node may be a solar panel installed in a household or a power plant operated by a utility company.

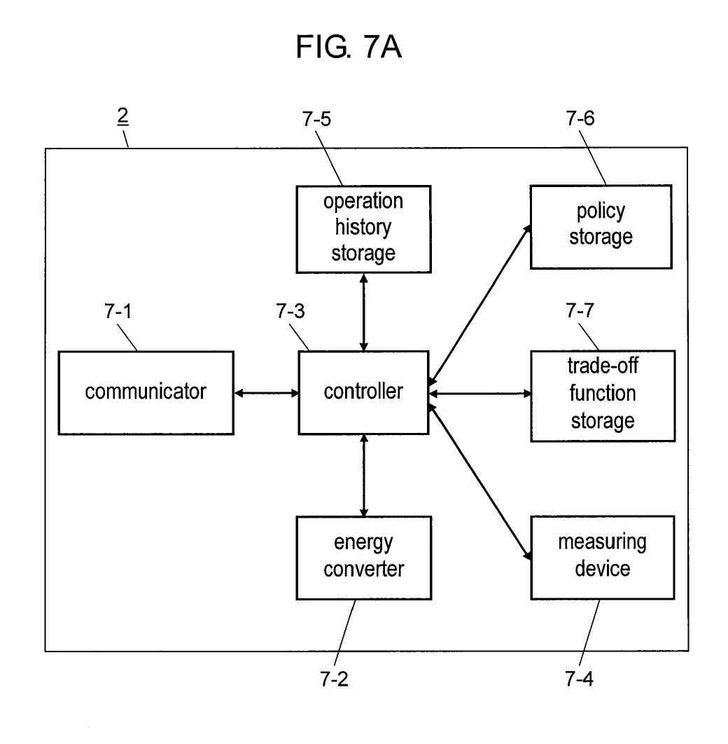

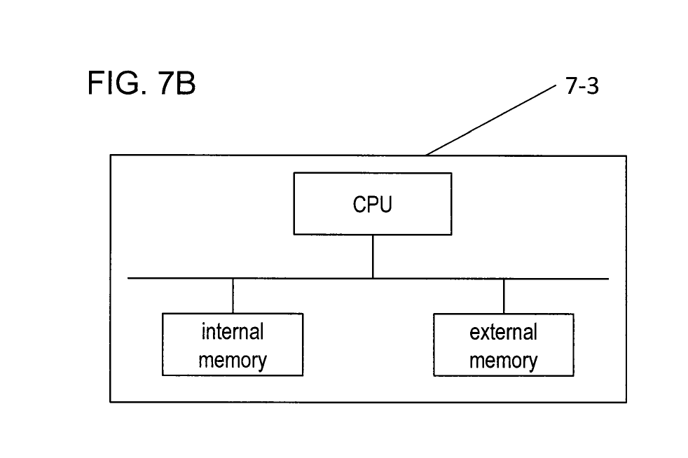

FIG. 7A is a schematic view showing the representative functional modules of an energy consuming node (EN) 2. A communicator 7-1 is configured to communicate with a coordinating node (CN) 1 and with other ENs 2 via a wired or wireless communication path. Communications among the CN 1 and ENs 2 can be performed with any type of communication protocol. If the communicator 7-1 is a wireless communicator, it is preferable to use a low power wireless module having a relatively long communication range. An energy converter 7-2 is configured to convert energy, such as electricity, into another type of energy under control of a controller 7-3. As shown in FIG. 7B, the controller 7-3 comprises, among other things, a CPU and internal and external memories which store, for instance, programs executable by the CPU to implement its intended functions. The energy converter 7-2 may be any type of machine or device which consumes energy to function. For example, if the EN 2 is an air conditioner, the energy converter 7-3 may be a motor which converts electricity into mechanical energy to operate a compressor of the air conditioner. If the EN 2 is a heater, the energy converter 7-2 is a heating element which converts electricity into heat. In FIG. 7A, the energy converter 7-2 is a part of the EN 2. However, the energy converter 7-2 may take a form in which it is an apparatus physically separated from the EN 2 but operated under the control of the EN 2.

A measuring device 7-4 is configured to make measurements regarding the operation of the energy converter 7-2 and supplies them to the controller 7-3. Based on the measurements, the controller 7-3 determines and stores in an operation history storage 7-5 at least an amount of energy consumed by the energy converter 7-2 for a predetermined time period, e.g., 24 hours from 12:00 am, respective time durations the energy converter 7-2 worked for the predetermined time period and an average energy consumption, which is the amount of consumed energy divided by the total time durations the energy converter 7-2 worked. The measuring device 7-4 also quantitatively measures results achieved by the energy converter 7-2. The measured results are stored in the operation history storage 7-5. The controller 7-3 receives a complaint from a user through a user interface and stores it in the operation history storage 7-5.

A policy storage 7-6 is configured to store a policy sent from the CN 1 in the domain to which the EN 2 belongs. The controller 7-3 implements the policy according to which the controller 7-3 controls energy consumption of the energy converter 7-2. A trade-off function storage 7-7 records a trade-off function of the EN 2. The controller 7-3 prepares the trade-off function based on recorded information in the operation history storage 7-5. A trade-off function may be expressed in any form, such as a mathematical equation or a table.

The operation of the EN 2 may be generally classified into two processes. One process is an autonomous control process. The other process is a process of updating the trade-off function and sending it to the CN 1. At the above-described timings, the communicator 7-1 receives a policy from the CN 1 of the domain to which the EN 2 belongs. The policy is then stored in the policy storage 7-6. In the autonomous control process, the controller 7-3 implements the received policy which guides the controller 7-3 to make decisions regarding the operation of the energy converter 7-2. Please note that the EN 2 of the present invention does not just passively follow the policy while implementing the policy, but it acts autonomously to explore a better course of action with the aid of the trade-off function. The trade-off function navigates the controller 7-3 to strike a better balance between the amount of energy consumed by the energy converter 7-2 and the degree of satisfaction towards the result achieved by the energy converter 7-2. In one embodiment, the policy includes a target ceiling value of one of the operation parameters of the energy converter 7-2, such as a target ceiling amount of energy consumable by the energy converter 7-2. In implementing such a policy, guided by the trade-off function stored in the function storage 7-7, the controller 7-3 explores a better balance between the amount of energy consumed by the energy converter 7-2 and the degree of satisfaction towards the result achieved by the energy converter 7-2, while trying to restrict energy consumption by the energy converter 7-2 below the given target ceiling amount.

The controller 7-3 updates the trade-off function when it receives the directive signal from the CN 1. As explained above, the trade-off function describes the relationship between the result from energy consumption and the degree of satisfaction towards the result. The controller 7-3 updates the degree of satisfaction in the trade-off function. Naturally, people rate the same result differently. Therefore, the degree of satisfaction is considered peculiar to individual users. The controller 7-3 analyzes the complaints by the use stored in the operation history storage 7-5 and personalizes the degree of satisfaction so as to more accurately reflect the user's sense of satisfaction towards the results. In one method, the degree of satisfaction is updated based on a distribution of the complaints in relation to the results.

The trade-off functions are used by the CN 1 to develop policies for the ENs 2 to collectively achieve the optimum energy usage. In one embodiment, the trade-off function is sent to the CN 1, along with a translator that translates for the CN 1 the results in the trade-off function into amounts of energy needed to achieve the results. Please note that a relationship between the result and the amount of energy needed to achieve the result is not constant. Under varying operation conditions, the result may change even with the same amount of energy is being used. Using the history data stored in the operation history storage 7-5, the controller 7-3 updates the translator to be sent to the CN 1 with the trade-off function.

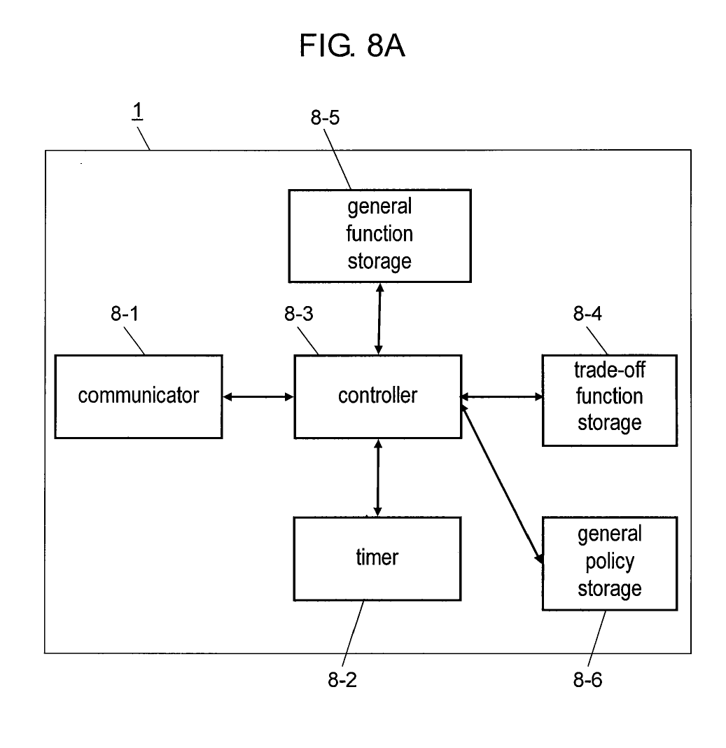

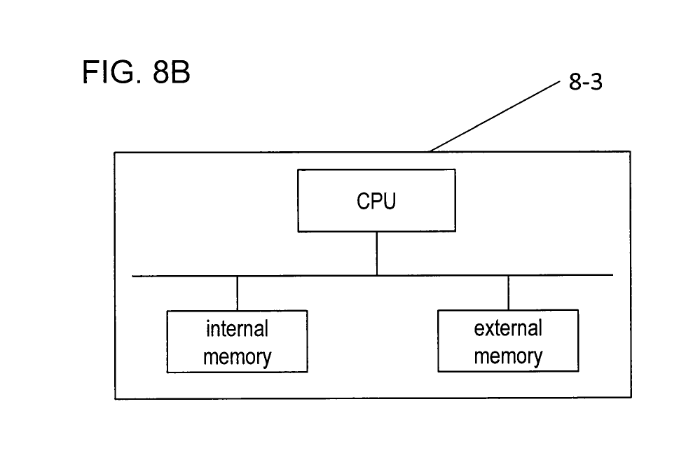

FIG. 8A is a schematic view showing functional modules of the CN 1 or a pseudo energy consuming node (PN). The CN 1 has a communicator 8-1 configured to communicate with ENs 2 in the domain to which the CN 1 belongs to. The communicator 8-1 may communicate with another CN 1 in another domain if the coordinating node is a PN. The communicator 8-1 performs communication via a wired or wireless communication path and preferably has a low power communication module with a relatively long communication range if it is a wireless communicator. A timer 8-2 counts time to trigger a controller 8-3 at regular intervals to initiate the process for developing policies for ENs 2. As shown in FIG. 8B, the controller 8-3 comprises, among other things, a CPU and internal and external memories which store, for instance, programs executable by the CPU to implement its intended functions.

A trade-off function storage 8-4 stores trade-off functions received from the ENs 2 in the domain to which the CN 1 belongs. The controller 8-3 then merges the received trade-off functions into a general trade-off function and stores it in a general function storage 8-5. The general trade-off function represents a trade-off function of the domain as a whole. A general policy storage 8-6 stores a general policy sent from an upper tier CN 1 (see FIGS. 4 and 6) or inputted by an operator of the CN 1. The controller 8-3 implements the general policy according to which it develops policies for the ENs 2 in the domain, using the general trade-off function stored in the general function storage 8-5.

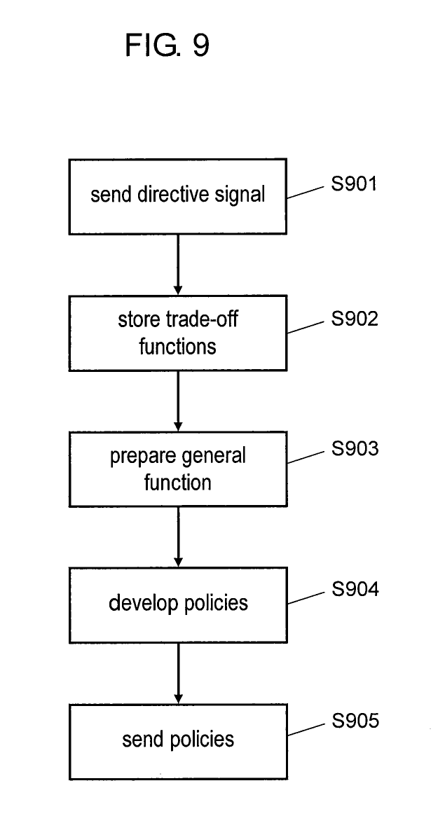

FIG. 9 is a flowchart showing the policy developing process performed by the CN 1. In Step 901, the controller 8-3 of the CN 1, triggered by the timer 8-2, broadcasts the directive signal to the ENs 2 in the domain via the communicator 8-1. In response, the ENs 2 send their trade-off functions to the CN 1. The controller 8-3 stores the received trade-off functions in the trade-off function storage 8-4 in Step 902. The controller 8-3 merges the received trade-off functions in Step 903 into a general trade-off function and stores it in the general function storage 8-5. In Step 904, the controller 8-3 implements the general policy stored in the general policy memory 8-6, according to which it develops policies for the ENs 2, using the general trade-off function in the general storage 8-5. The controller 8-3 then sends the developed policies respectively to the ENs 2 via the communicator 8-1 at Step 905.

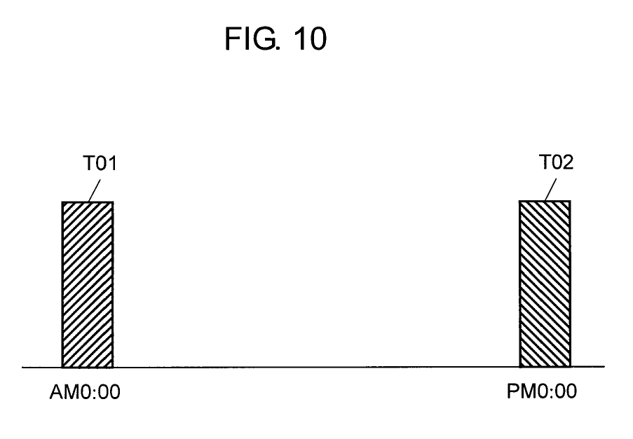

FIG. 10 shows one of the benefits of adopting the present invention. The shadow-hutched strips represent the policy developing processes performed at a CN. In FIG. 10, development of policies for ENs occurs every 12 hours. Although the length of the policy developing process depends on the number of the connected ENs and the computational power of the CN, the length is expected to be a couple of minutes to tens of minutes. This activity occurs only once in every 12 hours in FIG. 10. The role of a CN in the preset invention ends when it sends out policies to the connected ENs, and the CN is basically inactive until the next policy developing process. The ENs implement the policies according to which they autonomously control their energy consumptions. Therefore, the load on the CN is very light compared to the load on a controller in the conventional energy usage control system which closely monitors and control energy usages of all the ENs, which usually have no autonomous control capability. Also, communications with the ENs occur once in every 12 hours. Therefore, the load on the communication system is also very light.

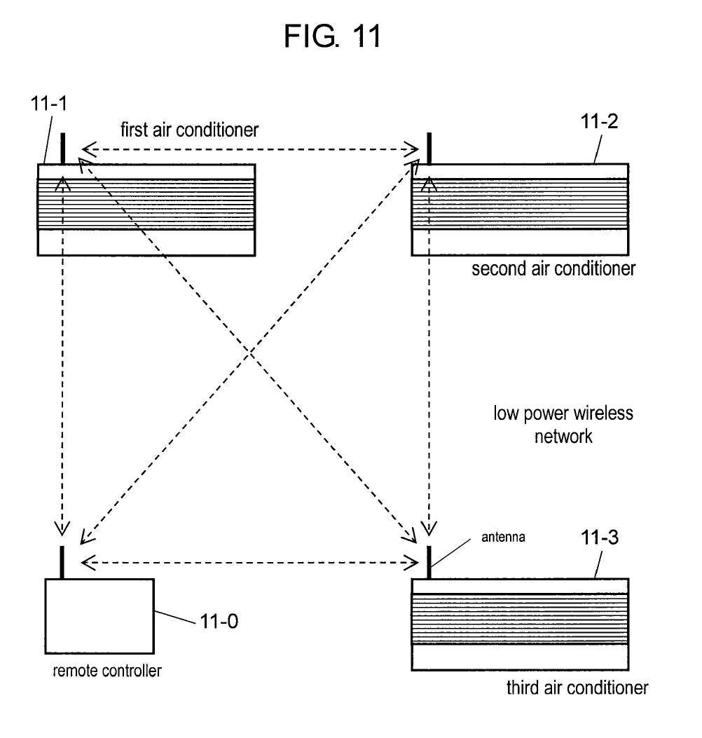

FIG. 11 shows an embodiment in which the present invention is applied to controlling energy usage by a group of air conditioners. In FIG. 11, one remote controller 11-0 and three air conditioners 11-1, 11-2 and 11-3 constitute a domain. The air conditioners 11-1, 11-2 and 11-3 are energy consuming nodes (EN) in the domain. The remote controller 11-0 is a coordinating node (CN) in the domain. In this embodiment, the remote controller 11-0 is a remote controller for the air conditioners. In these days, remote controllers for air conditioners are smart controllers with a micro computer therein sophisticated enough to perform the computation required to implement the present invention. The remote controller 11-0, the air conditioners 11-1, 11-2 and 11-3 wirelessly connect to each other to exchange communications among them via a low power wireless network. In this embodiment, the controller 11-0 controls daily usage of energy by the air conditioners 11-1 and 11-2, and thus basically develops policies every 24 hours. Under the policies, the air conditioners 11-1 and 11-2 autonomously control their energy consumptions for 24 hours in order to limit the total energy consumptions accrued for 24 hours below a target or goal amount. The time intervals at which the controller 11-0 develops new policies and during which the air conditioners 11-1 and 11-2 autonomously control their energy consumptions may be any time intervals, such as every 12 hours, every 24 hours, every two days or every week. As explained above, short time intervals, such as every five minutes or every ten minutes, should be avoided, as they increase computational load on the controller 11-0 and the air conditioners 11-1 and 11-2.

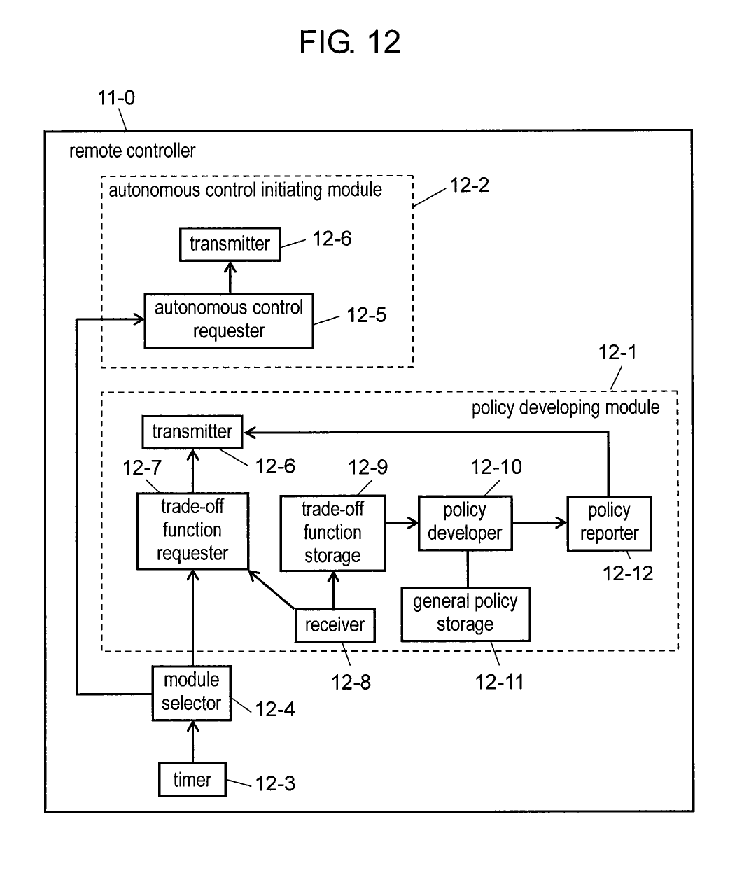

FIG. 12 is a block diagram showing the structure of the controller 11-0. The controller comprises two modules. One module is a policy developing module 12-1. The other module is an autonomous control initiating module 12-2. The controller 11-0 has a timer 12-3. The timer 12-3 triggers a module selector 12-4 according to a predetermined schedule. The module selector 12-4, triggered by the timer 12-3, determines whether to activate the policy developing module 12-1 or the autonomous control initiating module 12-2. If it is time to activate the autonomous control initiating module 12-2, the module selector 12-4 sends an activation signal to an autonomous control requester 12-5, which directs the air conditioners 11-1, 11-2 and 11-3 via a transmitter 12-6 to implement policies for their operation. The autonomous control requester 12-5 has a table which registers the air conditioners active in the domain and their respective operation conditions. One of the operation conditions indicates whether an air conditioner is subject to the control under the present invention. The user may want some of the air conditioners to be controlled under the present invention but not want to the other air conditioners to be part of the controlled group. The autonomous control requester 12-5 selectively sends the directive signal to those which are registered as being subject to the control under the present invention.

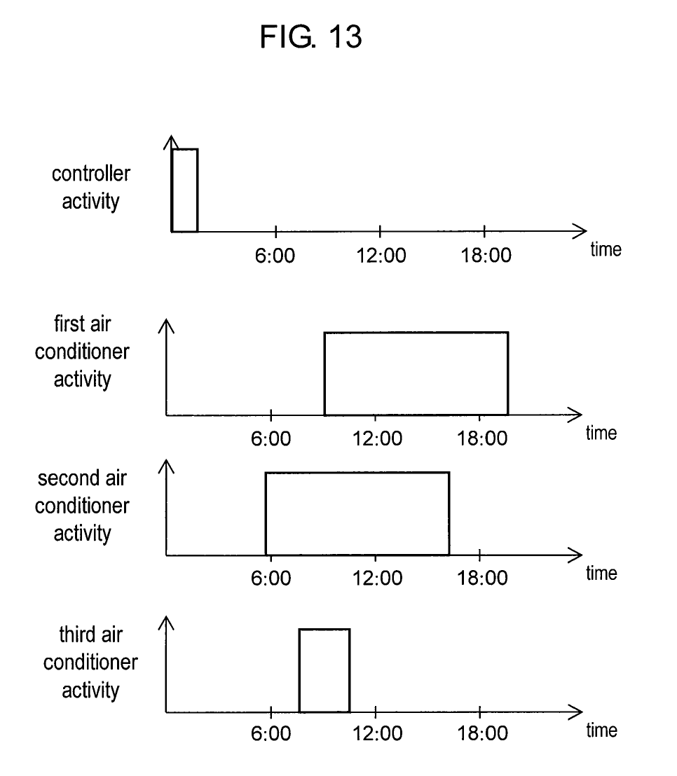

If it is time to activate the policy developing module 12-1, the module selector 12-4 sends an activation signal to a trade-off function requester 12-7. The trade-off function requester shares the registration table with the autonomous control requester which registers the air conditioners active in the domain. Triggered by the activation signal from the module selector 12-4, the trade-off function requester 12-7 sends the directive signal (see FIGS. 3 and 5) via the transmitter 12-6 to the registered air conditioners, i.e., the air conditioners 11-1, 11-2 and 11-3 (see Step 901 of FIG. 9). In this embodiment, the module selector 12-4, triggered by the timer 12-3, sends the activation signal to the trade-off function requester 12-7 every 24 hours. If communication speeds among the controller 11-0 and the air conditioners 11-1, 11-2 and 11-3 are slow, it is preferable that as shown in FIG. 13, the timer 12-2 is set to activate the trade-off function requester 12-7 when none of the air conditioners are working, e.g., at 12:00 am, because slow communication diverts the resources of the air conditioners from controlling their ordinary air-conditioning function. If the communication speeds are fast, the timer 12-2 may trigger the trade-off function requester 12-7 while any or all of the air conditioners are working. If the communication speed is slow, the timer 12-2 may store time tables as shown in FIG. 13 which show the time periods the air conditioners work.

In one embodiment, the active air conditioners are designed to send a notice to the controller 11-0 at regular intervals, e.g., every couple of minutes, which is received by the trade-off function requester 12-7 via the receiver 12-8. The notice may contain an energy consumption rate of the sending air conditioner and functions to notify the trade-off function requester 12-7 that the air conditioner sending the notice is active in the domain. Using the notices from the air conditioners, the trade-off function requester 12-7 maintains the registration table in such a way that when it receives a notice from a new air conditioner, it adds the new air conditioner in the table, and if it fails to receive a notice from a registered air conditioner for a predetermined time period, it deletes the air conditioner from the table, assuming that the air conditioner is no longer active in the domain. In addition to the regular time schedule clocked by the timer 12-3, when a new air conditioner is added in the table, or a registered air conditioner is removed from the table, the trade-off function requester 12-7 sends the directive signal to the registered air conditioners. An increase or decrease in the number of air conditioners active in the domain obsoletes the policies being in effect and thus triggers development of new policies for the active air conditioners.

Returning to FIG. 12, a receiver 12-8 receives trade-off functions from the air conditioners (Step 902 of FIG. 9), and the received trade-off functions are stored in a trade-off function storage 12-9. After waiting to receive trade-off functions from all of the air conditioners, the trade-off function storage 12-9 supplies the received trade-off functions to a policy developer 12-10. The trade-off function storage 12-9 may wait for a predetermined time and supply only the trade-off functions received as of the expiration of the predetermined time. By doing that, the trade-off function storage 12-9 can avoid being kept waiting for a trade-off function from an air conditioner which is no longer active in the domain.

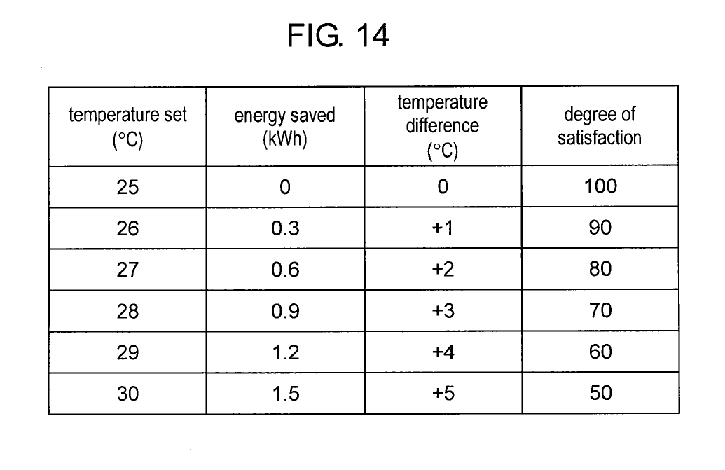

FIG. 14 shows an exemplary table for defining a trade-off function of one of the air conditioners 11-1, 11-2 and 11-3. It should be noted that the table shown in FIG. 14 is just one of the examples for defining the trade-off function of an air conditioner and the trade-off function can be expressed in other forms, such as an equation. In the table shown in FIG. 14, the left end column shows room temperatures set on the air conditioner and therefore achieved by the air conditioner. Thus, the room temperatures set and achieved by the air conditioner are the results of energy consumption by the air conditioner. The second column from the right shows differences between the most desirable room temperature (25° C.) and the temperatures set on the air conditioner. When the temperature of 28° C. is set on the air conditioner, the result (28° C. in the room temperature) will deviate by 3° C. from the most desirable room temperature.

The right end column shows degrees of satisfaction towards the achieved room temperatures. Thus, the table shows a relationship between temperatures set and degrees of satisfaction towards the set temperatures. The degree of satisfaction is a function of the temperature difference. As explained above, at the outset of operation of the air conditioner, the degree of satisfaction shown in the column may be derived from survey data and later modified according to the user's sense of satisfaction towards the temperature difference. In the table, the room temperature of 25° C. is given the value of “100,” which means that the highest number of the people surveyed feel comfortable at the room temperature of 25° C. Thus, according to the table shown in FIG. 14, 25° C. is assumed to be the most desirable room temperature for people. The number of the people who feel comfortable decreases as the room temperature rises from the most desirable temperature. If the temperature of 28° C. is sent on the air conditioner, the degree of satisfaction towards the result (28° C. in the room temperature) goes down to 70.

The second column from the left shows energy expected to be saved for 24 hours at each set temperature. When the temperature of 28° C. is set on the air conditioner, 0.9 KWh of energy is expected to be saved during one day of operations, compared to the energy necessary to maintain the most desirable temperature (25° C.). The table also shown in FIG. 14 shows a relationship between temperatures set and amounts of energy savable at the set temperatures. Thus, the table provides a translator translating the temperatures set into the amount of energy savable when those temperatures are set. The translator generally shows that a higher temperature is set than the most desirable room temperature, more energy is expected to be saved. In this embodiment, the translator is provided in the form of a table showing a relationship between the temperatures set and the amounts of energy savable at the temperatures set. The translator may be an equation describing the relationship. Also in this embodiment, the translator is provided by the EN 2 in the table showing the trade-off function. In one embodiment, the translator is set in advance in the CN 1. In such an embodiment, the table sent from the EN shows the temperatures set, the temperature differences and the degrees of satisfaction.

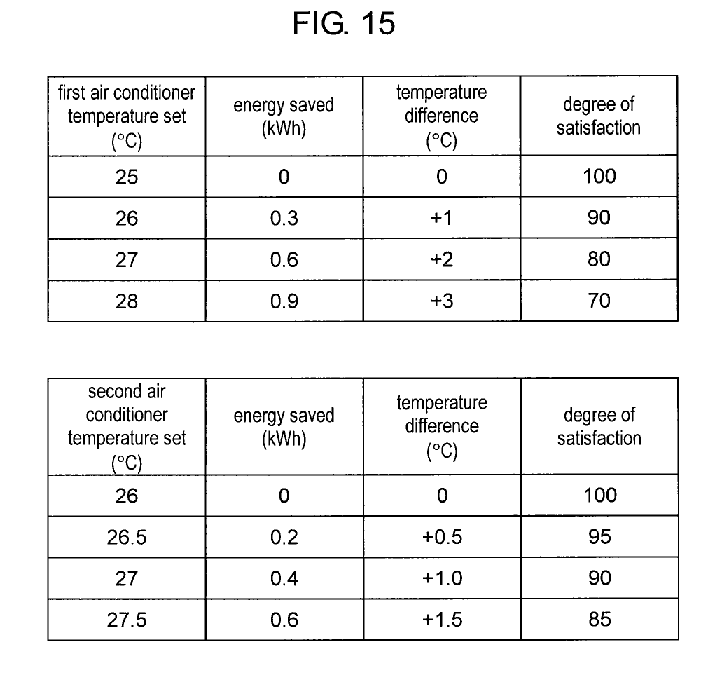

Returning to FIG. 12, after receiving the trade-off functions from the trade-off function storage 12-9, the policy developer 12-10 develops policies for the air conditioners. Suppose that the policy developer 12-10 receives trade-off functions only from the air conditioners 11-1 and 11-2 as shown in FIG. 15 and that the air conditioner 11-3 failed to send its trade-off function within the predetermined time. The policy developer 12-10 considers that the air conditioner 11-3 is not functioning properly and proceeds to develop policies for the air conditioners 11-1 and 11-2. The trade-off functions of the air conditioners 11-1 and 11-2 should naturally be different from each other as shown in FIG. 15 because the users of the air conditioners may be different which are supposed to have different degrees of satisfaction, and their operation environments may be different.

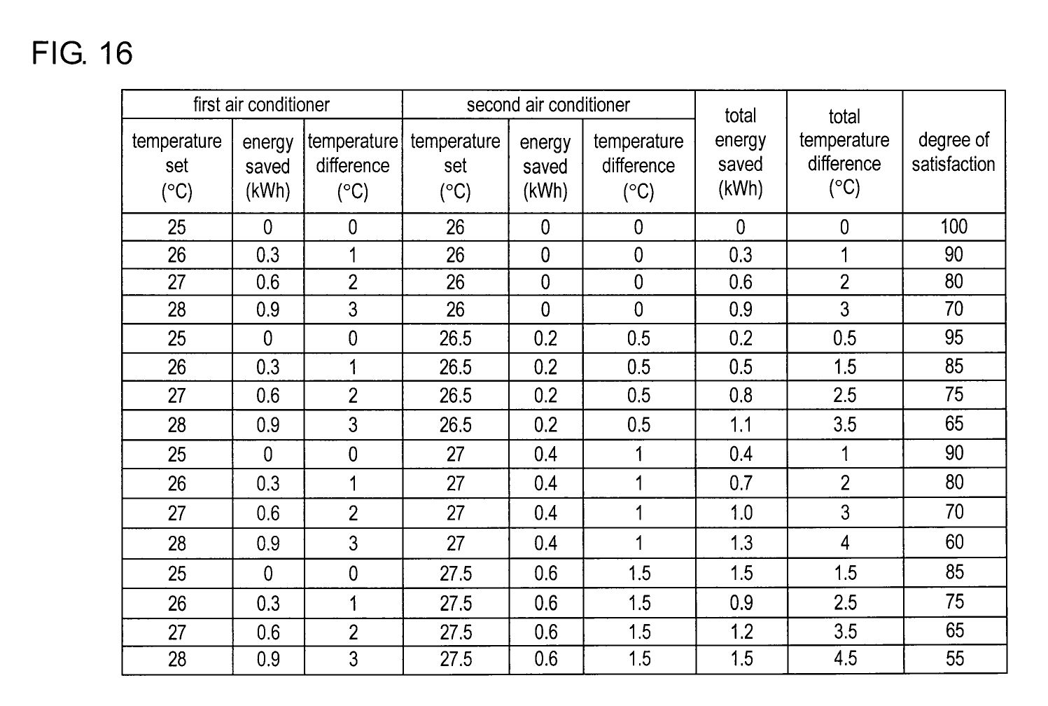

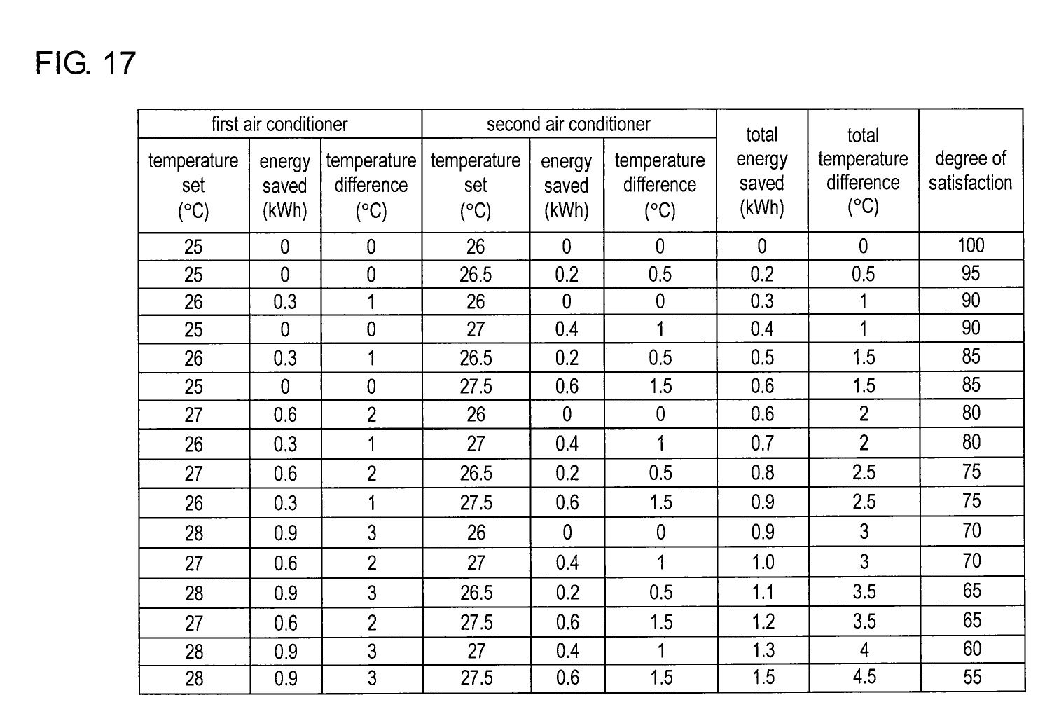

When developing policies for the air conditioners 11-1 and 11-2, the policy developer 12-10 first looks up a general policy storage 12-11 for a general policy to implement. Suppose that the general policy stored in the storage 12-11 contains a goal indicating that the energy consumed in the domain is to be saved by “at least 0.5 kWh” in total for 24 hours. The policy developer 12-10 then merges the tables of FIG. 15 into a single table as shown in FIG. 16, which shows all the combinations of the temperatures listed on the tables for the air conditioners 11-1 and 11-2. In the table shown in FIG. 16, each line in the column under the legend of “total energy savable” shows a sum of the energies expected to be saved which are listed in the same line for the air conditioners 11-1 and 11-2. Each line in the column under the legend of “total temperature difference” shows a sum of the temperature differences listed in the same line for the air conditioners 11-1 and 11-2. Each line in the column under the legend “degree of satisfaction” shows the degrees of satisfaction which are derived from the function, using the total temperature differences. The policy developer 12-10 then arranges the lines in the table shown in FIG. 16 into the table shown in FIG. 17 in which a line having a smaller value of the total temperature difference comes up in the table (see Step 903 of FIG. 9). The table shown in FIG. 17 represents a general trade-off function for the domain as a whole.

The policy developer 12-10, using the table shown in FIG. 17, develops policies for the air conditioners 11-1 and 11-2. To serve the users of the air conditioners better, the air conditioners should try to achieve the room temperatures which obtain a higher satisfaction from the users. However, the general policy contains the goal which indicates that 0.5 kWh of energy should be saved in total for 24 hours, compared to the energy necessary for the air conditioners 11-1 and 11-2 to maintain the most desirable room temperatures (25° C. for the air conditioner 11-1 and 26° C. for the air conditioner 11-2). Please note that the embodiment is being explained on a hypothesis that the users naturally set the room temperatures to their most desirable temperatures. Thus, the general policy in this embodiment requires the air conditioners 11-1 and 11-2 to limit the total energy consumption to lower by 0.5 kWh in total for 24 hours than they would consume to maintain the most desirable room temperatures.

The policy developer 12-10 looks up the table shown in FIG. 17 from the top of the table to the bottom to find the lines showing the total energy savable equal to or more than 0.5 kWh. Among the lines found, the policy developer 12-10 then selects line which shows the highest degree of satisfaction. In FIG. 17, there are two lines which qualify. One such line shows a combination of 26° C. for the air conditioner 11-1 and 26.5° C. for the air conditioner 11-2 which is expected to save 0.5 kWh of energy in total and achieve the satisfaction of 85. The other such line shows a combination of 25° C. for the air conditioner 11-1 and 27.5° C. for the air conditioner 11-2 which is expected to save 0.6 kWh of energy in total and achieve the satisfaction of 85. The policy developer 12-10 chooses the latter combination (25° C. for the air conditioner 11-1 and 27.5° C. for the air conditioner 11-2) because the latter combination can achieve the same satisfaction with less energy. The policy developer 12-10 then prepares policies for the air conditioners 11-1 and 11-2 (see Step 904 of FIG. 9). The policy for the air conditioner 11-1 includes a goal temperature of 25° C. The policy for the air conditioner 11-2 includes a goal temperature of 27.5° C. These policies are then supplied to a policy reporter 12-12, which sends the policies respectively to the air conditioners 11-1 and 11-2 via the transmitter 12-6. Instead of the room temperatures to be maintained, the policies for the air conditioners 11-1 and 11-2 may contain goal amounts of energy to be saved (0 kWh for the air conditioner 11-1 and 0.6 kWh for the air conditioner 11-2).

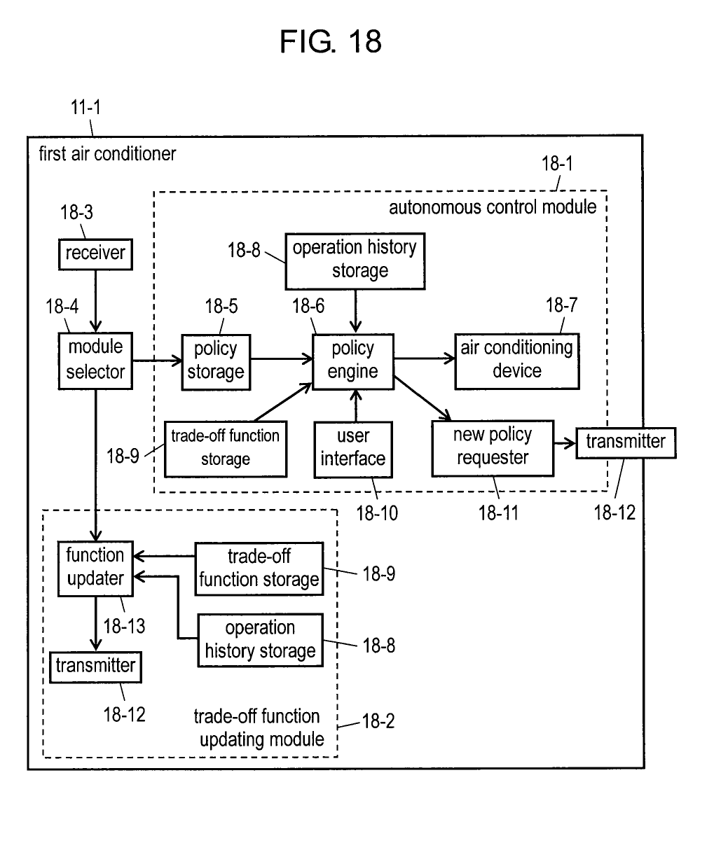

FIG. 18 is a block diagram showing functional structure of the air conditioner 11-1. The air conditioners 11-2 and 11-3 have the identical structure. The air conditioner consists of two modules. One module is an autonomous control module 18-1. The other module is a trade-off function updating module 18-2. First, a receiver 18-3 receives the policy from the controller 11-0. The received policy is stored in a policy storage 18-5. Then, when the receiver 18-3 receives the autonomous control initiating signal from the controller 11-0, a module selector 18-4 activates the autonomous control module 18-1. The module 18-1 has a policy engine 18-6 which reads out the policy from the policy storage 18-5 and implements the policy according to which it controls the operation of an air-conditioning device 18-7. The policy engine 18-6 receives operation data from the air-conditioning device 18-7 at regular intervals. The operation data includes an energy consumption rate of the air conditioning device or an amount of electricity consumed by the air conditioning device for the latest interval, and a time duration the air-conditioning device worked. The operation data also includes temperature data which indicates a room temperature of the latest interval. The policy engine 18-6 stores the operation data from the air-conditioning device 18-7 in an operation history storage 18-8. Thus, the operation history storage 18-8 records a history of the energy consumption rate of the air-conditioning device 18-7, time durations the air-conditioning device worked and a history of the room temperature. By integrating the energy consumption rates recorded from the time the last policy was received, the policy engine 18-6 calculates the total amount of energy which has been consumed by the air-conditioning device 18-7 since the last policy was received and stores it in the operation history storage 18-8. From the total amount of energy consumed by the air-conditioning device and the total time duration that the air-conditioning device worked, the policy engine 18-6 calculates an average energy consumption of the air-conditioning device 18-7 and stores it in the operation history storage 18-8. A trade-off function is stored in a trade-off function storage 18-9, which is accessible by the policy engine 18-6. The module 18-1 also has a user interface 18-10, one of the functions of which is to receive a temperature setting by the user.

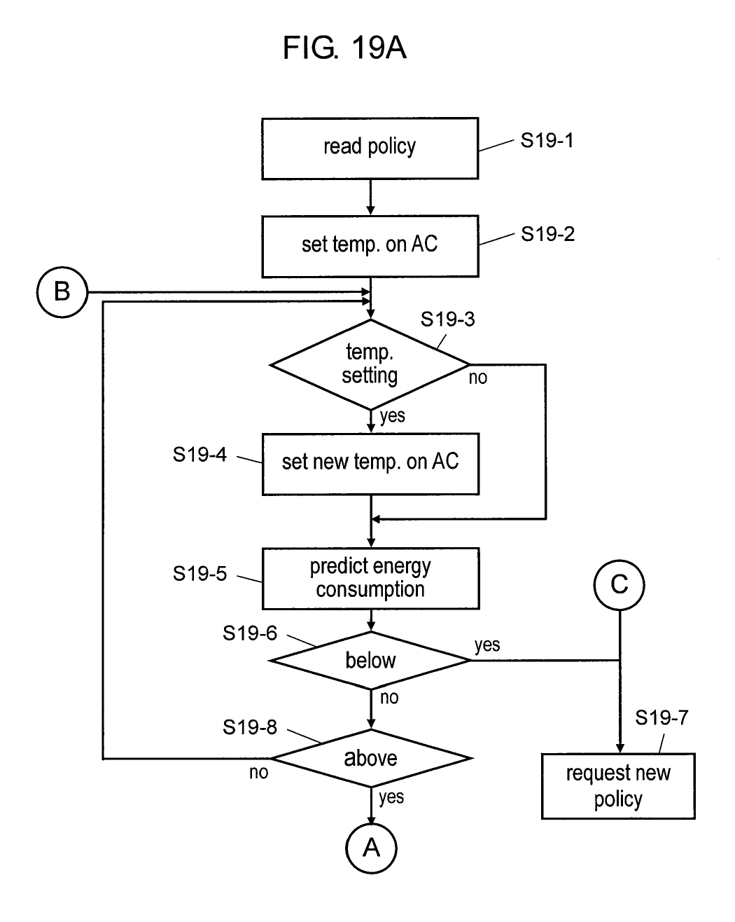

FIG. 19A is a flowchart showing exemplary processes performed by the policy engine 18-6 during the autonomous control. Triggered by the autonomous control initiating signal from the controller 11-0, the policy engine 18-6 reads out the policy from the policy storage 18-5 in Step 19-1. As explained above, the policy includes a goal temperature of 25° C., which has been developed for the air conditioner 11-1 by the controller 11-0 to save at least 05 kWh of energy in total by the air conditioners 11-1 and 11-2. In Step 19-2, the policy engine 18-6 provides the goal temperature to the air conditioning device 18-7, which operates to maintain the room temperature at 25° C. The received policy may include an amount of energy to be saved (0 kWh), instead of the goal temperature (25° C.). The trade-off function storage 18-9 stores the upper table shown in FIG. 15 because the table was devised by the air conditioner 11-1. If the received policy contains the amount of energy to be saved (0 kWh), the policy engine 18-6 translates it into the room temperature of 25° C., using the trade-off function stored in the storage 18-9. From the operation history data stored in the storage 18-9, the policy engine 18-6 also finds the amount of energy needed to maintain the room temperature at 25° C. The amount of energy found is the ceiling amount of energy consumable by the air-conditioning device 18-7 for the next 24 hour period.

While the air-conditioning device 18-7 operates to maintain the room temperature at 25° C., the policy engine 18-6 determines in Step 19-3 whether the user sets a new temperature on the air-conditioning device 18-7. A temperature setting by the user is considered a complaint from the user because it suggests that the user is not satisfied with the room temperature. However, it is not certain, when the new temperature is set, how the new temperature will affect the energy consumption by the air-conditioning device 18-7. The policy engine 18-6 accepts the temperature setting by the user and provides the newly set temperature to the air-conditioning device 18-7 in Step 19-4, which now operates to maintain the room temperature at the newly set temperature.

During the autonomous control, the policy engine 18-6 monitors the energy consumed by the air conditioning device 18-7, which is stored in the history storage 18-8, and in Step 19-5 predicts a total energy that the air-conditioning device 18-7 will likely have consumed before the end of the 24 hour period. Under varying operation environments, the air-conditioning device 18-7 may need a different amount of energy today to maintain the room temperate at 25° C. than needed yesterday to maintain the same room temperature. If the policy engine 18-6 predicts that the air-conditioning device will likely have consumed significantly less energy than the ceiling amount of energy for the 24 hour period (Step 19-6), the policy engine 18-6 directs a new policy requester 18-11 to requests a new policy to the controller 11-0 (Step 19-7). The new policy requester 18-11 then sends the request signal (FIG. 3) to the controller 11-0 via a transmitter 18-12. If the policy engine 18-6 predicts that the air-conditioning device 18-7 will likely have consumed more energy than the ceiling amount of energy at the end of the 24 hour period (Step 19-8), the policy engine 18-6 will move to Step 19-9 in FIG. 19B. The policy engine will otherwise return to Step 19-3.

In FIG. 19B, the policy engine 18-6 looks to the user's preference to the operation in Step 19-9. The user of the air conditioner 11-1 is required to register in advance whether the user prefers an energy saving operation or an operation to achieve a higher degree of satisfaction. The user's preference towards the operation may be registered in the controller 11-0 and is included in the policy to be sent to and implemented by the air conditioner 11-1. Alternatively, the user's preference may be registered in the air conditioner 11-1 and referenced by the policy engine 18-6 while implementing the policy. If the policy engine 18-6 finds that the user of the air conditioner 11-1 prefers an operation to achieve a higher degree of satisfaction, it will return to Step 19-3. In the subsequent processes, the policy engine 18-6 skips Step 19-8 even if it predicts that the air-conditioning device 18-7 will likely have consumed more energy than the ceiling amount of energy at the end of the 24 hour period. If the policy engine finds that the user prefers an energy saving operation, it determines a new target temperature or to what degree it should raise the room temperature from 25° C. to limit the energy consumption by the air-conditioning device below the ceiling amount of energy consumable (Step 19-10). In one embodiment, the new target temperature is determined using the following equation:

P=α·(Tₛ−Tₕ)·W·t

where P is an amount of energy expected to be saved at the new target temperature Ts, α is a rate at which energy consumption changes per every one degree (° C.) (α≈10%), Tₕ is the current room temperature, W is an expected average energy consumption for the 24 hour period, and t is the total time duration the air conditioner is expected to operate at the new target temperature before the end of the 24 hour period. P is the difference between the ceiling amount of energy consumable and the total amount of energy predicted to be consumed by the air-conditioning device 18-7 for the 24 hour period if it will operate to maintain the current room temperature until the end of the 24 hour period. Therefore, the above equation can yield the new target temperature.

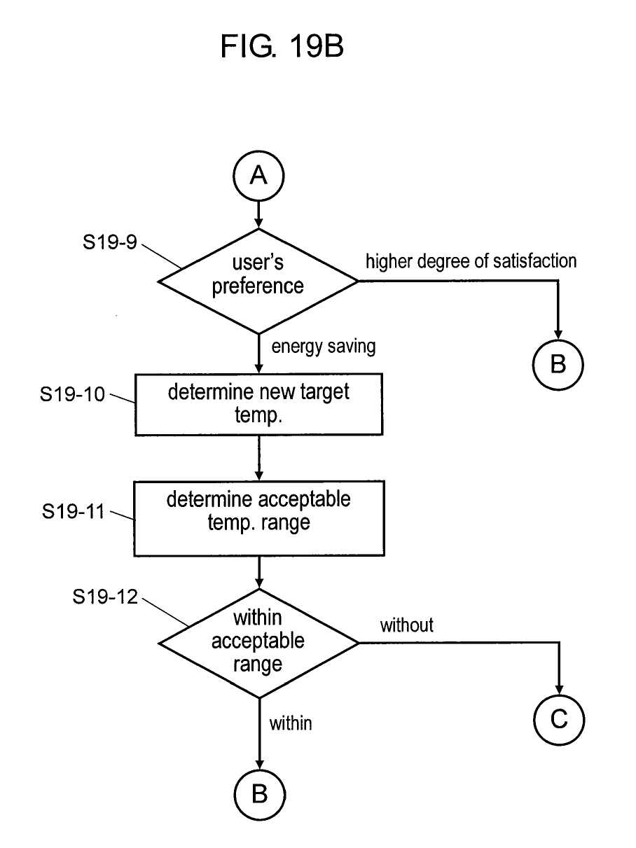

The policy engine 18-6 then determines the range of room temperature acceptable to the user in Step 1-11. FIG. 20 shows an exemplary function describing the relationship between the room temperature and the degree of satisfaction. The degree of satisfaction takes a value from 0 to 100. The degrees of satisfaction listed in the right end column of the upper table shown in FIG. 15 are derived from the function shown in FIG. 20 in relation to the temperature differences noted in the second column from the right of the table. FIG. 20 also illustrates a range of the degree of satisfaction. As shown in FIG. 20, the upper limit of the range is 100, and the lower limit of the range is 80. The degree “80” is considered peculiar to the user of the air conditioner 11-1 and indicates the minimum degree of satisfaction the user may accept. This minimum acceptable degree of satisfaction can be translated by the function shown in FIG. 20 into the highest room temperature that the user may accept. According to FIG. 20 and also to FIG. 15, the degree “80” of satisfaction corresponds to the room temperature of 27° C., which is considered the highest temperature that the user of the air conditioner 11-1 may accept. Therefore, the policy engine 18-6 may safely assume that it can raise the room temperature between 25° C. and 27° C. without compromising the user's sense of comfort.

The policy engine 18-6 determines the minimum acceptable degree of satisfaction based on the operation history stored in the operation history storage 18-8. The operation history storage 18-8 records past temperature settings by the user in relation to the room temperatures and the degrees of satisfaction. A temperature setting is considered a complaint by the user. If the user feels not comfortable, the user sets a lower or higher temperature on the air-conditioning device 18-7. By monitoring the past temperature settings by the user, the policy engine 18-6 determines a distribution of the temperature settings in relation to the degrees of satisfaction by the user. The minimum acceptable degree of satisfaction is a threshold observed in the distribution, below which a number of temperature settings are observed, whereas above which few or no temperature settings are observed. The user may set the minimum acceptable degree of satisfaction on either the controller 11-0 or the air conditioner 11-1. If the minimum acceptable degree is set on the controller 11-0, it is included in the policy to be sent to and implemented by the air conditioner 11-1.

Returning to FIG. 19B, the policy engine 18-6 determines in Step 19-12 whether the new target temperature is within the acceptable temperature range. If the new target temperature is higher than 27° C., the policy engine 18-6 will direct the new policy requester 18-11 to requests a new policy to the controller 11-0 (Step 19-7). The new policy requester then sends the request signal (FIG. 3) to the controller 11-0 via a transmitter 18-12. If the new target temperature is equal to or lower than 27° C., the policy engine 18-6 will return to Step 19-3.

Returning to FIG. 18, when the receiver 18-3 receives the directive signal from the controller 11-0, the module selector 18-4 activates the trade-off function updating module 18-2. The module 18-2 has a function updater 18-13, which updates the trade-off function stored in the trade-off function storage 18-9. In this embodiment, the trade-off function of the air conditioner 11-1 is represented by the upper table shown in FIG. 15. The function updater 18-13 first updates the translator, i.e., the relationship between the temperatures set (the “temperature set” column) and the amounts of energy savable (the “energy savable” column) noted in the table. An amount of energy savable (P) can be derived from the same equation as used above, which is:

P=α·(Tₛ−Tₕ)·W·t

where Ts is a set of temperatures (in the upper table shown in FIG. 15, Ts is 25° C., 26° C., 27° C. or 28° C.), Tₕ is an average of the room temperatures maintained by the air-conditioning device 18-7 for the last 24 hour period, W is the average electricity consumed for the last 24 hour period, and t is the total time duration the air conditioner was used for the last 24 hours. All of these parameters required to calculate P are stored in the operation history storage 18-8.

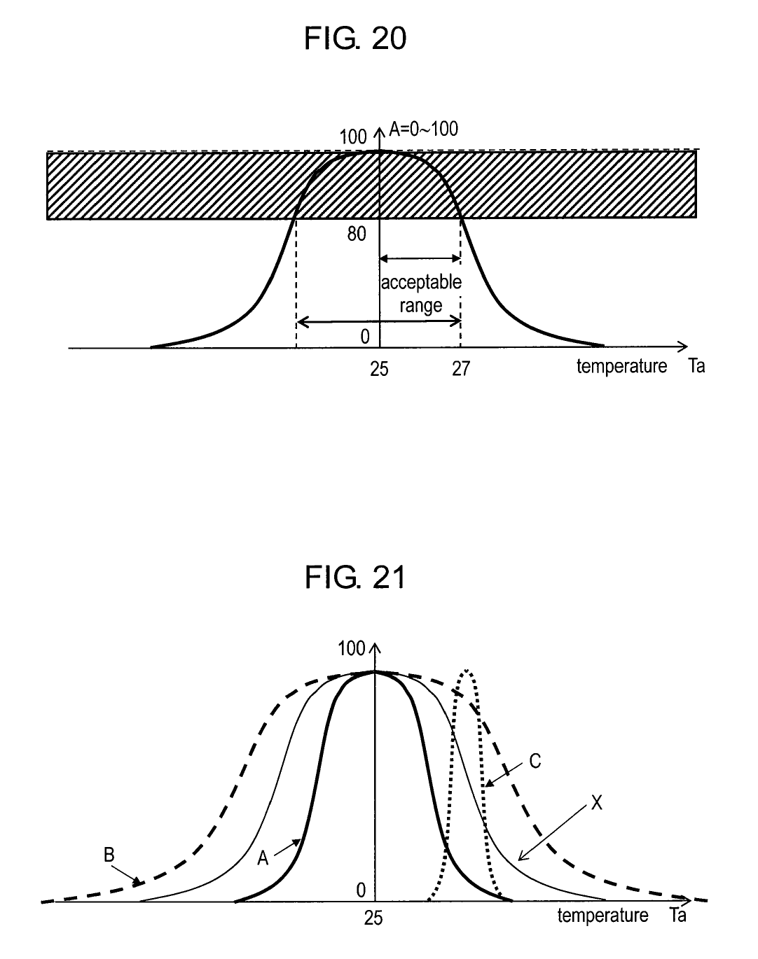

The function updater 18-13 also updates the relationship between the temperatures set (the “temperature set” column) and the degrees of satisfaction (the “degree of satisfaction” column) noted in the table. ISO 7730 describes the PMV (Predicted Mean Vote) and PPD (Predicted Percentage Dissatisfaction) indices and specifies acceptable conditions for thermal comfort. A function describing the relationship between temperatures and degrees of satisfaction towards the temperatures is derived similarly according to ISO 7730. Such a function is shown as a distribution X in FIG. 21 and used as the original trade-off function. The distribution X is derived basically with survey data. Although the original function may provide an objective degree of satisfaction towards temperatures, it is considered not accurately reflecting the sense of comfort personal to the user of the air conditioner 11-1. The operation history storage 18-8 records past temperature settings by the user in relation to the room temperatures and the degrees of satisfaction. The function updater 18-13 analyzes the past temperature settings stored in the operation history storage 18-8 and modifies the distribution X to personalize it for the user of the air conditioner 11-1.

In one embodiment, the distribution X may be modified to coincide with a normal distribution having the mean and variance calculated from the temperatures set by the user. As a result, the distribution X may be modified to look like a distribution A, B or C as shown in FIG. 21. The distribution A has the same mean value as that of the distribution X, but its variance is narrower than that of the distribution X. Therefore, the distribution A tells that the user A accepts only a narrower range of temperature variance than the general public. The distribution B has a mean value substantially equal to that of the distribution A, but its variance is wider than that of the distribution A. The user A and the user B probably feel most comfortable at more or less the same temperature. But the user B accepts a wider range of temperature variance than the user A. The user C feels most comfortable at a temperature higher that of the users A and B and accepts only a very narrow range of temperature variance. The modified relationship between the set temperatures and the degrees satisfaction is considered more accurately reflecting the user's sense of comfort towards temperatures set. The function updater 18-13 then sends the updated trade-off function to the controller 11-0 via a transmitter 18-12.

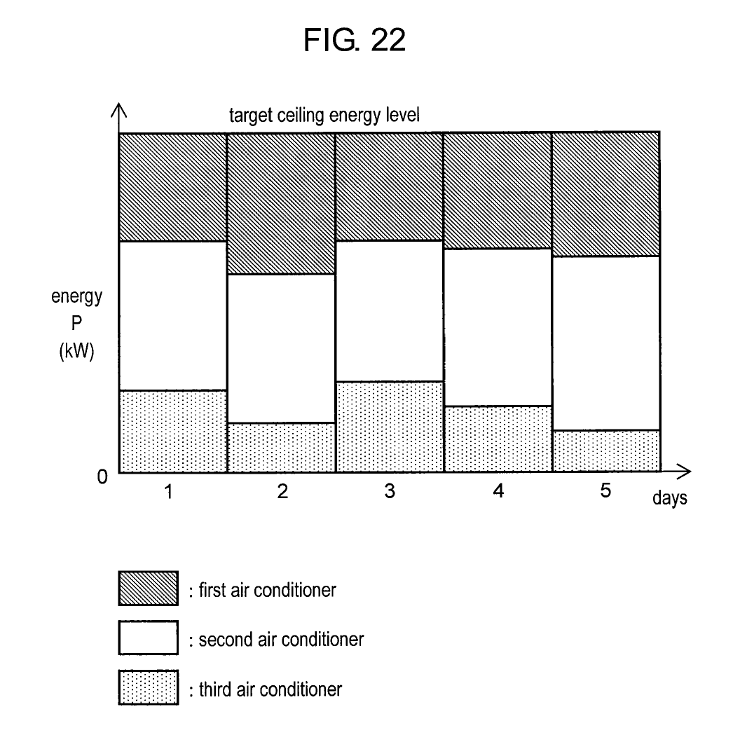

In the above embodiment, the general policy includes a target amount of energy to be saved in total by the air conditioners, and the remote controller 11-0 develops policies which include goal temperatures to be maintained or goal amounts of energy to be saved by the respective air conditioners. In another embodiment, the general policy includes a total ceiling amount of energy consumable by the air conditioners, and the controller 11-0 develops polices which include target ceiling amounts of energy consumable by the respective air conditioners. FIG. 22 is a graph showing an exemplary 5-day history of energies consumed by the air conditioners 11-1, 11-2 and 11-3 under the policies which include target ceiling amounts of energy consumable by the respective air conditioners. In the example shown in FIG. 22, the air conditioners consume amounts of energy which vary daily but the total energy consumed by the air conditioners is constant through the 5 days.

There are ways to develop policies which include target ceiling amounts of energy consumable by the respective air conditioners. The simplest way to develop such policies is to allocate a total ceiling amount to the air conditioners according to a history of energy consumptions by the air conditioners. Suppose, for example, that the air conditioners consumed an amount (P_{d-1}) of energy in total yesterday (d-1) in which the air conditioners 11-1, 11-2 and 11-3 respectively consumed P1_{d-1}, P2_{d-1} and P3_{d-1}. The target ceiling amounts of energy consumable today (d) by the air conditioners may be expressed as follows:

P1_{d}=Pₜ·P1_{d-1}/P_{d-1}

P2_{d}=Pₜ·P2_{d-1}/P_{d-1}

P2_{d}=Pₜ·P3_{d-1}/P_{d-1}

where Pₜ is the total ceiling amount for today, and P_{d-1}=P1_{d-1}+P2_{d-1}+P3_{d-1}.

Even if the air conditioner 11-3 becomes inactive, the target ceiling amounts of energy consumable today (d) by the air conditioners 11-1 and 11-2 may be expressed as follows:

P1_{d}=Pₜ·P1_{d-1}/P_{d-1}

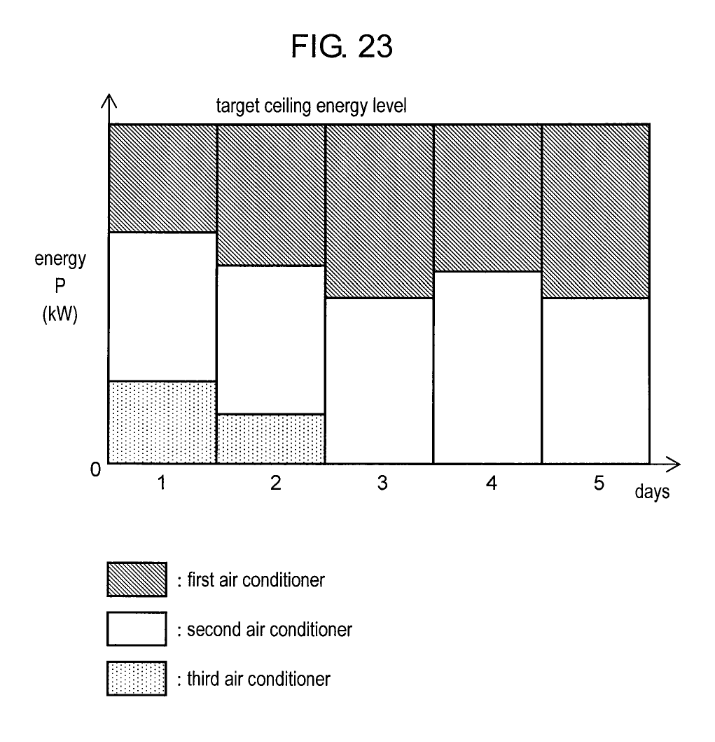

P2_{d}=Pₜ·P2_{d-1}/P_{d-1}

where Pₜ is the total ceiling amount for today, and P_{d-1}=P1_{d-1}+P2_{d-1}. FIG. 23 is a graph showing an exemplary 5-day history of energies consumed by the air conditioners 11-1, 11-2 and 11-3 in which the air conditioner under the policies which include target ceiling amounts of energy consumable by the respective air conditioners, wherein the air conditioner 11-3 becomes inactive in the domain on the third day.

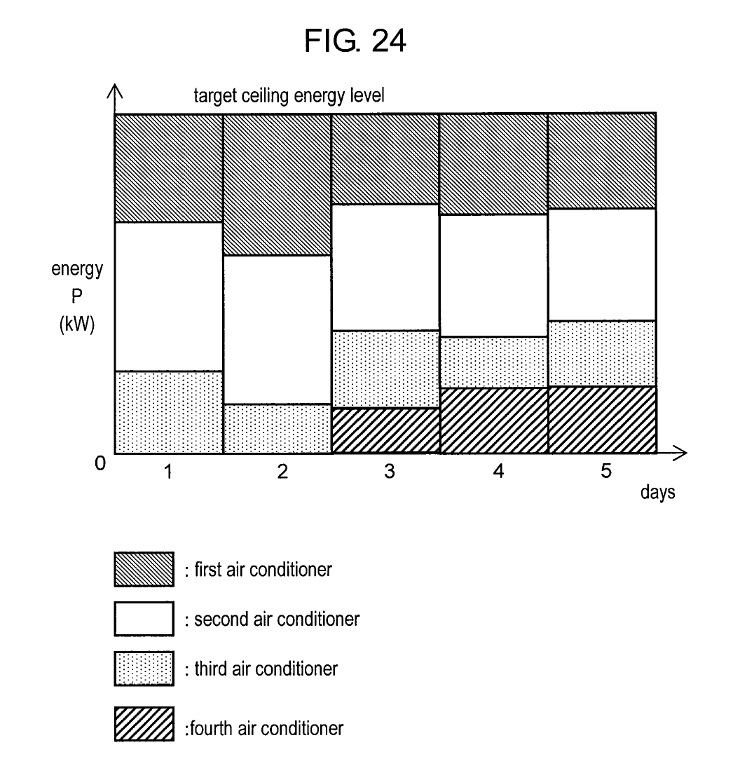

FIG. 24 is a graph showing an exemplary 5-day history of energies consumed by the air conditioners 11-1, 11-2 and 11-3 in which the air conditioner under the policies which include target ceiling amounts of energy consumable by the respective air conditioners, wherein a new air conditioner 11-4 joins on the third day. On the third day, the controller 11-1 receives a trade-off function from the air conditioner 11-4 and allocates the total ceiling amount of energy to the air conditioners 11-1, 11-2, 11-3 and 11-4.

When receiving a policy including the ceiling amount (P1_{d}) of energy consumable today, the air conditioner 11-1 determines a target temperature to be achieved. P1_{d} may be expressed by the following equation:

P1_{d}=W·H_{AVE}

where W is electricity consumed by the air conditioner, and H_{AVE} is the average hours the air conditioner is used per day. Here, W may be expressed as follows:

W=∂·|Tₜₐᵣ−Tᵣₒₒₘ|+β

where Tₜₐᵣ is a target temperature, Tᵣₒₒₘ is a room temperature, and α and β are constants. In other words, energy consumed by the air conditioner is proportional to a difference between the target temperature (Tₜₐᵣ) and the room temperature (Tᵣₒₒₘ). The first equation maybe solved using the second equation as follows:

P1_{d}/H_{AVE}=α·|Tₜₐᵣ−Tᵣₒₒₘ|+β

### Therefore,

IfTₜₐᵣ>Tᵣₒₒₘ,Tₜₐᵣ=(P1_{d}/H_{AVE}−β)/α+Tᵣₒₒₘ

IfTₜₐᵣ>Tᵣₒₒₘ,Tₜₐᵣ=(β−P1_{d}/H_{AVE}−β)/α+Tᵣₒₒₘ

IfTₜₐᵣ=Tᵣₒₒₘ,Tₜₐᵣ=β

α and β are constants. H_{AVE} is from a measured value. Therefore, the target temperature can be obtained from the target ceiling amount of energy P1_{d}. Above is an exemplary method of deriving the target temperature from the target ceiling amount of energy consumable. There are other methods usable for the same purpose. These other methods include the use of fuzzy control and the use of modeling.

In the above embodiment, the energy consuming nodes (ENs) are all air conditioners. The ENs may include other kinds of electric appliances, such as a refrigerator, a washer-dryer and a combination thereof. Although they are different kinds of appliances, their trade-off functions are prepared to be comparable to each other. A refrigerator consumes less energy when a set temperature is higher. However, since the temperatures of foods therein become also high, ice cream, for example, becomes prone to melt, and freshness of vegetables is quickly compromised. As in the case of air conditioner, a comparable degree of satisfaction can be devised for a refrigerator. A washer-dryer consumes large energy during the drying process, compared to the washing process. In these days, the drying process may be performed under two alternative modes. One mode is a time saving mode under which large energy is consumed to dry clothes in a short time. The other mode is an energy saving mode under which small energy is consumed but it takes longer to dry clothes. Given that the drying process may be performed under different modes, a comparable degree of satisfaction can be devised also for a washer-dryer. Likewise, a comparable degree of satisfaction can be devised for other appliances, such a toaster, a rice cooker, a heat-pump water heater and an induction heater, where the result of their consumed energy is evaluated by a comparable degree of satisfaction.

From the invention thus described, it will be obvious that the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A coordinating node in an energy usage control system comprising:
a processor of a computer system and a memory that stores programs executable by the processor to implement:
a receiver that receives trade-off functions from energy consuming nodes, wherein the coordinating node and the energy consuming nodes collectively form a domain, and a trade-off function from an energy consuming node describes a relationship between a result of energy consumption by the energy consuming node and a degree of satisfaction towards the result; and
a policy developer that develops policies respectively for the energy consuming nodes, based on the received trade-off functions, wherein the policies each contain at least one goal and/or at least one procedure to guide the respective energy consuming node to control its energy usage such that the energy consuming nodes collectively achieve an optimum energy saving for the domain.

2. The coordinating node according to claim 1, wherein the memory stores a general policy which contains at least one goal and/or at least one procedure to guide the policy developer to develop the policies.

3. The coordinating node according to claim 1, wherein the policy developer, based on the received trade-off functions, devises a general trade-off function which describes results achieved by the energy consuming nodes and the degrees of satisfaction towards the results, wherein the policy developer develops the policies, based on the general trade-off function.

4. The coordinating node according to claim 1, wherein the processor further implements a transmitter that broadcasts a directive signal requesting the energy consumption nodes to send their trade-off functions to the coordinating node.

5. The coordinating node according to claim 4, wherein the transmitter broadcasts the directive signal at regular intervals.

6. The coordinating node according to claim 5, wherein the transmitter broadcasts the directive signal every 24 hours.

7. The coordinating node according to claim 4, wherein the transmitter broadcasts the directive signal when none of the energy consuming nodes is in operation.

8. The coordinating node according to claim 4, wherein the receiver waits only for a predetermined time period to receive the trade-off functions.

9. The coordinating node according to claim 4, wherein the transmitter selectively sends the energy consuming nodes an activation signal directing the energy consuming nodes to implement the policies.

10. The coordinating node according to claim 4, wherein
the processor further implements a registrar that receives via the receiver a notice from energy consuming nodes active in the domain at regular intervals and registers the active energy consuming nodes in a registration table in the memory, and
the registrar adds a new energy consuming node in the registration table when it receives for the first time the notice from the new energy consuming node, whereas it deletes an registered energy consuming node from the registration table when it fails to receive the notice of the registered energy consuming node for a predetermined time period.

11. The coordinating node according to claim 9, wherein the transmitter broadcasts the directive signal to the registered energy consuming nodes when the new energy consuming node is added in the registration table or the registered energy consuming node is deleted from the registration table.

12. The coordinating node according to claim 1, wherein the energy consuming nodes are electric appliances including any of an air conditioner, a refrigerator, a washer-dryer, a toaster, a rice cooker, a heat-pump water heater an induction heather.

13. The coordinating node according to claim 1, wherein the energy consuming nodes are air conditioners and the coordinating node is a remote controller for the air conditioners.

14. The coordinating node according to claim 13, wherein the policy contains a target temperature.

15. The coordinating node according to claim 13, wherein the policy contains an amount of energy to be saved.

16. The coordinating node according to claim 13, wherein the general policy contains a total amount of energy to be saved by the energy consuming nodes in the domain.

17. The coordinating node according to claim 1, wherein the domain includes an energy generating node.

18. A method of coordinating energy consuming nodes in an energy usage control system comprising:
computer implemented steps performable by a processor of a cording node to implement:
receiving trade-off functions from energy consuming nodes, wherein the coordinating node and the energy consuming nodes collectively form a domain, and a trade-off function from an energy consuming node describes a relationship between a result of energy consumption by the energy consuming node and a degree of satisfaction towards the result; and
developing policies respectively for the energy consuming nodes, based on the received trade-off functions, wherein the policies each contain at least one goal and/or at least one procedure to guide the respective energy consuming node to control its energy usage such that the energy consuming nodes collectively achieve an optimum energy saving for the domain.

19. The method according to claim 18, wherein the processor further implements storing a general policy which contains at least one goal and/or at least one procedure to guide the policy developer to develop the policies.

20. The method according to claim 18, wherein developing policies comprises, based on the received trade-off functions, devising a general trade-off function which describes results achieved by the energy consuming nodes and the degrees of satisfaction towards the results and developing the policies, based on the devised general trade-off function.

21. The method according to claim 18, wherein the processor further implements broadcasting a directive signal requesting the energy consumption nodes to send their trade-off functions to the coordinating node.

22. The method according to claim 21, wherein broadcasting a directive signal comprises broadcasting the directive signal at regular intervals.

23. The method according to claim 22, wherein broadcasting the directive signal at regular intervals comprises broadcasting the directive signal every 24 hours.

24. The method according to claim 21, wherein broadcasting a directive signal comprises broadcasting the directive signal when none of the energy consuming nodes is in operation.

25. The method according to claim 21, wherein receiving trade-off functions comprises waiting only for a predetermined time period to receive the trade-off functions.

26. The method according to claim 21, wherein the processor further implements selectively sending the energy consuming nodes an activation signal directing the energy consuming nodes to implement the policies.

27. The method according to claim 21, wherein the processor further implements:
receiving a notice from energy consuming nodes active in the domain at regular intervals; and
adding a new energy consuming node in a registration table when receiving for the first time the notice from the new energy consuming node, whereas deleting an registered energy consuming node from the registration table when failing to receive the notice of the registered energy consuming node for a predetermined time period.

28. The method according to claim 26, wherein broadcasting the directive signal comprises broadcasting the directive signal to the registered energy consuming nodes when the new energy consuming node is added in the registration table or the registered energy consuming node is deleted from the registration table.

29. The method according to claim 18, wherein the energy consuming nodes are electric appliances including any of an air conditioner, a refrigerator, a washer-dryer, a toaster, a rice cooker, a heat-pump water heater an induction heather.

30. The method according to claim 18, wherein the energy consuming nodes are air conditioners and the coordinating node is a remote controller for the air conditioners.

31. The method according to claim 30, wherein the policy contains a target temperature.

32. The method according to claim 30, wherein the policy contains an amount of energy to be saved.

33. The method according to claim 30, wherein the general policy contains a total amount of energy to be saved by the energy consuming nodes in the domain.

34. The method according to claim 18, wherein the domain includes an energy generating node.

35. An article of manufacture comprising one or more recordable media storing instructions which, when executed by a processor of a coordinating node, cause the processor to perform a method comprising:
receiving trade-off functions from energy consuming nodes, wherein the coordinating node and the energy consuming nodes collectively form a domain, and a trade-off function from an energy consuming node describes a relationship between a result of energy consumption by the energy consuming node and a degree of satisfaction towards the result; and
developing policies respectively for the energy consuming nodes, based on the received trade-off functions, wherein the policies each contain at least one goal and/or at least one procedure to guide the respective energy consuming node to control its energy usage such that the energy consuming nodes collectively achieve an optimum energy saving for the domain.

36. The article of manufacture according to claim 35, wherein the processor further implements storing a general policy which contains at least one goal and/or at least one procedure to guide the policy developer to develop the policies.

37. The article of manufacture according to claim 35, wherein developing policies comprises, based on the received trade-off functions, devising a general trade-off function which describes results achieved by the energy consuming nodes and the degrees of satisfaction towards the results and developing the policies, based on the devised general trade-off function.

38. The article of manufacture according to claim 35, wherein the processor further implements broadcasting a directive signal requesting the energy consumption nodes to send their trade-off functions to the coordinating node.

39. The article of manufacture according to claim 38, wherein broadcasting a directive signal comprises broadcasting the directive signal at regular intervals.

40. The article of manufacture according to claim 39, wherein broadcasting the directive signal at regular intervals comprises broadcasting the directive signal every 24 hours.

41. The article of manufacture according to claim 38, wherein broadcasting a directive signal comprises broadcasting the directive signal when none of the energy consuming nodes is in operation.

42. The article of manufacture according to claim 38, wherein receiving trade-off functions comprises waiting only for a predetermined time period to receive the trade-off functions.

43. The article of manufacture according to claim 38, wherein the processor further implements selectively sending the energy consuming nodes an activation signal directing the energy consuming nodes to implement the policies.

44. The article of manufacture according to claim 38, wherein the processor further implements:
receiving a notice from energy consuming nodes active in the domain at regular intervals; and
adding a new energy consuming node in a registration table when receiving for the first time the notice from the new energy consuming node, whereas deleting an registered energy consuming node from the registration table when failing to receive the notice of the registered energy consuming node for a predetermined time period.

45. The article of manufacture according to claim 26, wherein broadcasting the directive signal comprises broadcasting the directive signal to the registered energy consuming nodes when the new energy consuming node is added in the registration table or the registered energy consuming node is deleted from the registration table.

46. The article of manufacture according to claim 18, wherein the energy consuming nodes are electric appliances including any of an air conditioner, a refrigerator, a washer-dryer, a toaster, a rice cooker, a heat-pump water heater an induction heather.

47. The method according to claim 18, wherein the energy consuming nodes are air conditioners and the coordinating node is a remote controller for the air conditioners.

48. The article of manufacture according to claim 30, wherein the policy contains a target temperature.

49. The article of manufacture according to claim 47, wherein the policy contains an amount of energy to be saved.

50. The article of manufacture according to claim 47, wherein the general policy contains a total amount of energy to be saved by the energy consuming nodes in the domain.

51. The article of manufacture according to claim 35, wherein the domain includes an energy generating node.
